(19) United States
(12) Patent Application Publication
(10) Pub. No.: US 2011/0161440 A1
(43) Pub. Date: Jun. 30, 2011

(54) SYSTEM AND METHOD FOR ENHANCING DIGITAL CONTENT

(75) Inventors: Eric Juvet, Seattle, WA (US); Tod C. Turner, Kenmore, WA (US)

(73) Assignee: LIVECHIME, INC., Kenmore, WA (US)

(21) Appl. No.: 12/828,569

(22) Filed: Jul. 1, 2010

Related U.S. Application Data
(63) Continuation-in-part of application No. 12/611,557, filed on Nov. 3, 2009.
(60) Provisional application No. 61/222,756, filed on Jul. 2, 2009.
(60) Provisional application No. 61/228,292, filed on Jul. 24, 2009.
(60) Provisional application No. 61/198,148, filed on Nov. 3, 2008.

(51) Int. Cl. G06F 15/16

(52) U.S. Cl. 709/206

(57) ABSTRACT

A computer program product being tangibly embodied in a computer-readable medium and including computer-executable code for enhancing an electronic document including a plurality of advertisements, the computer program product computer-executable code including: code for receiving a request corresponding to an identifier associated with a given advertisement responsively to a user's interaction with the electronic document; and code for launching a clientless chat application that corresponds to the advertisement responsively to the receiving, regardless of whether the electronic document allows chat-application code to be embedded therein.

This application:

is a continuation-in-part of U.S. patent application Ser. No. 12/611,557, filed Nov. 3, 2009, entitled SYSTEM AND METHOD FOR ENHANCING DIGITAL CONTENT, which claims priority of U.S. Patent Application Ser. Nos.: 61/198,148, filed Nov. 3, 2008, entitled SYSTEM AND METHOD FOR ATTACHING A REAL TIME VIRTUAL PRESENCE, and 61/222,756, filed Jul. 2, 2009, entitled SYSTEM AND METHOD FOR ENHANCING DIGITAL CONTENT, and

claims priority of U.S. Patent Application Ser. No. 61/228,292, filed July 24, 2009, entitled SYSTEM FOR SUPERIMPOSING A CHAT SESSION ONTO AN ONLINE ADVERTISEMENT,

all of which are incorporated herein by reference as if being set forth in their respective entireties herein.

### FIELD OF THE INVENTION

The present invention generally relates to digital content delivery and computerized chat systems and methods.

### BACKGROUND OF THE INVENTION

Computerized chat services (referred to herein as “chat services”) provide for real-time or substantially real-time communications between a plurality of users via computing devices. Chat services generally provide a relatively anonymous, non-threatening way for parties, such as prospective agents, brokers, buyers and/or sellers, to communicate. A “chat” application, as used herein, generally refers to computing device executable code being tangibly embodied on a computing device—readable media, such as a memory, which provides for real-time or substantially real-time communications between a plurality of registrants via computing devices (i.e., chat services). Once a chat has been initiated, a chat user can typically communicate text to another communicating chat user by entering it into their computing device, such as by typing on a keyboard. The entered text will typically appear on the other chat user's computing device display.

While the present invention is not limited to electronic commerce channels, it is believed sell-through via electronic commerce channels, e.g., websites, can be enhanced using chat services. Indeed, some have indicated that sell-through on web sites may be increased by 500% if chat services are offered via product web pages. It is thus believed that chat services can fill a necessary void in online sales, allowing buyers to communicate substantially anonymously, such as with prospective agents, brokers or sellers, without fear of sales pressure.

Further, electronic commerce channels for amateur and/or sellers having relatively limited computing and/or financial resources are expanding. For example, online classifieds, such as those commercially available via www.ebay.com and www.craigslist.com are generally finding greater acceptance and use among sellers and prospective buyers. Other expanding electronic commerce markets may include the automobile and real estate markets, and service provider markets, such as for insurance services, for example.

Due to the nature of e-commerce channels (e.g., 24/7/365 availability) offering conventional chat services for use with e-commerce channels may typically require one or more seller persons to continuously monitor for chat requests by interacting with a personal computer. Amateur and/or sellers having relatively limited computing and/or financial resources may typically not be able/willing to provide such coverage. Further, conventional chat services may typically require chat application code, such as JAVA code corresponding to the chat application, to be inserted into a web page. Where a listing web page is operated by a third party that does not allow for chat application code insertion, conventional chat applications may not be suitable for use. Conventional chat services may thus be relatively ill-suited for certain uses.

### SUMMARY

In certain embodiments of the present invention, a computer program product being tangibly embodied in a computer-readable medium and including computer-executable code for enhancing an electronic document including a plurality of advertisements, the computer program product computer-executable code including: code for receiving a request corresponding to an identifier associated with a given advertisement responsively to a user's interaction with the electronic document; and code for launching a clientless chat application that corresponds to the advertisement responsively to the receiving, regardless of whether the electronic document allows chat-application code to be embedded therein.

In certain embodiments of the present invention, a computer program product being embodied in a computer-readable medium and including computer-executable code for enhancing an electronic document including at least one link and being served via a network responsively to a request received via the network and correspondent to the electronic document may be provided.

The computer program product computer-executable code may include code for receiving a chat request via the network corresponding to activation of the at least one link included in the electronic document.

The computer program product computer-executable code may include code for automatically identifying an identifier responsively to the received chat request.

The computer program product computer-executable code may include code for automatically identifying at least one preference associated with the identified identifier.

The computer program product computer-executable code may include code for automatically sending an SMS message including a mobile chat link indicative of the received chat request in a first mode, wherein the first mode corresponds to the at least one identified preference indicating an SMS messaging preference.

The computer program product computer-executable code may include code for automatically sending an e-mail message including a personal computer chat link indicative of the received chat request in a second mode, wherein the second mode corresponds to the at least one identified preference indicating an e-mail messaging preference.

The computer program product computer-executable code may include code for automatically sending both SMS and e-mail messages, the SMS message including the mobile chat link and the e-mail message including the personal computer chat link, each of the mobile chat and personal computer chat links being indicative of the received chat request, in a third mode, wherein the third mode corresponds to the at least one identified preference indicating both SMS and e-mail messaging preferences.

The computer program product computer-executable code may include code for selectively automatically causing a mobile mode of a chat application corresponding to the received chat request to be instantiated responsively to receiving a request via the network correspondent to activation of the mobile mode link.

The computer program product computer-executable code may include code for selectively automatically causing a personal computer mode of the chat application corresponding to the received chat request to be instantiated responsively to receiving a request via the network correspondent to activation of the personal computer mode link.

The mobile mode instantiation of the chat application may be adapted for use with a mobile device and be less computing resource intensive than the personal computer mode instantiation of the chat application, which may be adapted for use with a personal computer.

The electronic document may include a plurality of content portions, and the link may correspond to at least one of the content portions.

The computer program product may further include code for identifying an identifier associated with the at least one of the content portions of the electronic document responsively to the correspondent request for or serving of the electronic document.

The computer program product may further include code for serving the identified identifier contemporaneously with the electronic document, wherein the served identifier forms at least a part of the at least one link.

The instantiated chat application may be displayed with the electronic document such that the chat application visually corresponds with the at least one content portion of the served electronic document.

The computer program product may further include code for causing the served electronic document to be framed responsively to receiving the request correspondent to activation of the mobile chat mode or personal computer mode link.

The electronic document may be displayed in a first window, and the chat application be instantiated in a second window. The electronic document may be displayed in a same window in which the chat application is instantiated.

The computer program product may further include code for selectively updating the instantiated chat application irrespective of the electronic document.

The chat request may include a uniform resource locator having an identifier appended thereto.

Certain embodiments of the present invention may not require a code or applets to be inserted into or otherwise incorporated into a website to provide chat functionality. Advantageously, only a link may need to be inserted, for example. This may provide particularly well suited for use with websites where traditional chat code or applets may not be inserted.

In certain embodiments of the present invention, a computer program product being tangibly embodied in a computer-readable medium and including computer-executable code for enhancing an electronic document including at least one advertisement portion and at least one other advertising or content portion may be provided. The at least one advertisement portion may be automatically selected for dynamic incorporation into the at least one electronic document when served via a network substantially contemporaneously with the electronic document responsively to a request received via the network from a user's computing device and being correspondent to the electronic document.

The computer program product computer-executable code may include code for identifying an identifier associated with the at least one advertisement portion of the electronic document responsively to the correspondent request for or serving of the electronic document.

The computer program product computer-executable code may include code for serving the identified identifier contemporaneously with the electronic document and separate from the advertisement portion, wherein the served identifier forms at least a part of a link incorporated with the electronic document when the served electronic document is displayed.

The computer program product computer-executable code may include code for causing a chat application to be instantiated responsively to and dependently upon receiving a second request via the network and corresponding to the served electronic document incorporated link.

The instantiated chat application is displayed via the user's computing device without a client chat application being executed by the user's computing device.

The instantiated chat application may be displayed with the electronic document such that the chat application is superimposed with substantially only the at least one advertisement portion of the served electronic document.

The computer program product computer-executable code may include code for causing the served electronic document to be framed responsively to receiving the second request.

The electronic document may be displayed in a first window, and the chat application may be instantiated in a second window.

The electronic document may be displayed in a same window in which the chat application is instantiated.

The computer program product computer-executable code may include code for selectively updating the chat application irrespective of the electronic document.

The computer program product computer-executable code may include code for updating the identifier associated at least one of the content portions of the electronic document irrespective of at least one other content portion of the electronic document.

The second request may include a uniform resource locator having the identifier appended thereto. The identifier includes a GUID.

The link and the second request may include a same alphabetic, numeric or alphanumeric string appended to a uniform resource locator.

The instantiated chat application may be displayed separate from the electronic document.

The computer program product computer-executable code may include code for sending a second link responsively to and dependently upon receiving a second request via the network and corresponding to the served electronic document incorporated link.

The computer program product computer-executable code may include code for sending a plurality of second links responsively to and dependently upon receiving the second request via the network and corresponding to the served electronic document incorporated link.

Each of the second links may correspond to a different type of computing device having an associated processing capability.

A type of chat application instantiated dependently upon the second request may correspond to which of the second links was activated.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts, and in which:

FIG. 1A illustrates a block diagrammatic representation of a process according to an embodiment of the present invention;

FIG. 1B illustrates a block diagrammatic representation of a process according to an embodiment of the present invention;

FIG. 2 illustrates link formats according to embodiments of the present invention;

FIG. 3A illustrates a block diagrammatic representation of a process according to an embodiment of the present invention;

FIG. 3B illustrates a block diagrammatic representation of a process according to an embodiment of the present invention;

FIG. 4A illustrates an electronic document according to an embodiment of the present invention;

FIG. 4B illustrates a superimposed link and content according to an embodiment of the present invention;

FIG. 4C illustrates an electronic document according to an embodiment of the present invention;

FIG. 4D illustrates a superimposed link and content according to an embodiment of the present invention;

FIG. 5 illustrates a block diagrammatic representation of a process according to an embodiment of the present invention;

FIG. 6A illustrates a block diagrammatic representation of a process according to an embodiment of the present invention;

FIG. 6B illustrates a block diagrammatic representation of a process according to an embodiment of the present invention;

FIG. 6C illustrates a block diagrammatic representation of a process according to an embodiment of the present invention;

FIG. 7 illustrates a block diagrammatic representation of a process according to an embodiment of the present invention;

FIG. 8A illustrates an electronic document and chat instantiation according to an embodiment of the present invention;

FIG. 8B illustrates an electronic document and chat instantiation according to an embodiment of the present invention;

FIG. 8C illustrates a superimposed link and content and chat instantiation according to an embodiment of the present invention;

FIG. 8D illustrates an electronic document and chat instantiation according to an embodiment of the present invention.

FIG. 9 illustrates a block diagrammatic representation of a process according to an embodiment of the present invention;

FIG. 10A illustrates a block diagrammatic representation of a process according to an embodiment of the present invention;

FIG. 10B illustrates a block diagrammatic representation of a process according to an embodiment of the present invention;

FIG. 11 illustrates a block diagrammatic representation of a system according to an embodiment of the present invention;

FIG. 12 illustrates an electronic document incorporating a chat link according to an embodiment of the present invention;

FIG. 13 illustrates an electronic document that may be used to monitor for fulfilling chat requests according to an embodiment of the present invention;

FIG. 14 illustrates an electronic document incorporating a chat link and chat application according to an embodiment of the present invention;

FIG. 15 illustrates an electronic document incorporating a chat link and chat application according to an embodiment of the present invention;

FIG. 16 illustrates an electronic document that may be used to monitor for fulfilling chat requests according to an embodiment of the present invention;

FIGS. 17-21G illustrate a non-limiting embodiment of the present invention; and

FIG. 22 illustrates a block diagrammatic view of a process according to an embodiment of the present invention.

### DETAILED DESCRIPTION OF THE PREFERRED EMBODIMENTS OF THE INVENTION

It is to be understood the figures and descriptions of the present invention have been simplified to illustrate elements that are relevant for understanding the present invention, while eliminating, for purposes of clarity, many other elements found in typical computing, networking and chat applications, systems and methods. Because such elements are well known in the art, and because they do not facilitate a better understanding of the present invention, a discussion of such elements is not provided herein.

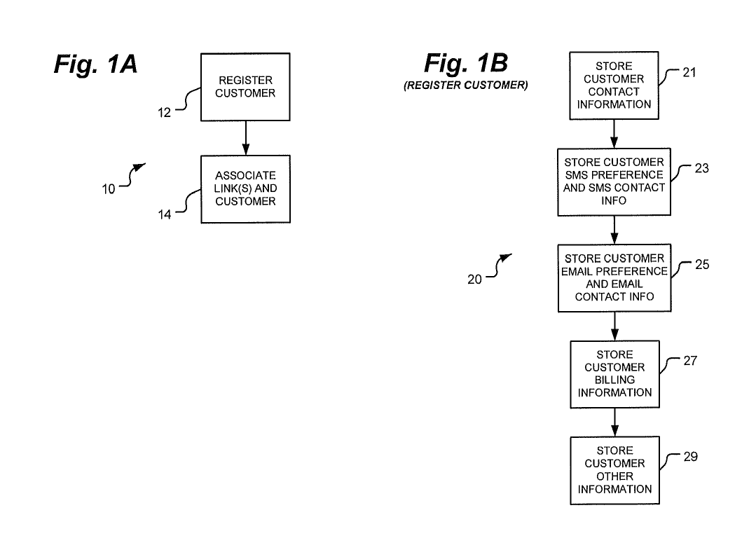

Referring now to FIG. 1A, there is shown a block diagrammatic representation of a process 10 according to an embodiment of the present invention. Process 10 generally includes registering a user or customer at block 12 and associating one or more chat service links with the registered customer at block 14. Such a customer or user will be referred to herein as a “link registrant” or “registrant” for non-limiting purposes of explanation. Processing at block 12 may take the form of a user registration process conventionally utilized by users of computing devices in association with Internet websites, for example. Processing at block 14 many include storing information items associated with registrants in one or more databases, for example.

By way of non-limiting explanation, “computing device”, as used herein, refers to a general purpose computing device that includes a processor. A processor generally includes a Central Processing Unit (CPU), such as a microprocessor. A CPU generally includes an arithmetic logic unit (ALU), which performs arithmetic and logical operations, and a control unit, which extracts instructions (e.g., code) from a computer readable medium, such as a memory, and decodes and executes them, calling on the ALU when necessary. “Memory”, as used herein, generally refers to one or more devices or media capable of storing data, such as in the form of chips or drives. For example, memory may take the form of one or more random-access memory (RAM), read-only memory (ROM), programmable read-only memory (PROM), erasable programmable read-only memory (EPROM), or electrically erasable programmable read-only memory (EEPROM) chips, by way of further non-limiting example only. Memory may be internal or external to an integrated unit including the processor. Memory may take the form of magnetic or optical—technology based storage media. Memory may be internal or external to a computing device. Memory may store a computer program, e.g., code or a sequence of instructions being operable by the processor. In certain embodiments of the present invention, one or more of the elements provided may take the form of code being executed using one or more computing devices, such as in the form of computer device executable programs or applications being stored in memory. There are various types of computing devices, having varying processing and memory capabilities, such as: personal computers (like those that are commercially available from Dell and Apple Corp.), and personal digital assistants and smart phones (like those that are commercially available from Apple Corp. and Research in Motion), by way of non-limiting example only.

“Website”, as used herein, generally refers to a collection of one or more electronic documents (e.g., webpages) that are available via a computer network, such as the global interconnection of computers and computer networks commonly referred to as the Internet. By way of non-limiting example, a website may be accessed at a given address on the World Wide Web (i.e., “www.URL.TLD”), and include a home page, which is the first webpage visitors typically see when they enter the site. A website may also contain additional webpages. Webpages may be fixed, and/or dynamically generated in response to website visitor webpage requests. By way of further non-limiting example only, the World Wide Web is a system of Internet servers that support HTML (Hypertext Markup Language), such that a website visitor can jump from one webpage to another webpage simply by clicking on references to other webpages, such as hot spots or hot links (referred to herein as “links”). Web browsing applications, such as Microsoft's Internet Explorer and Google's Chrome, are available applications used to access websites on the World Wide Web. Other computer network types and/or protocols and/or mark up languages and/or applications may be used. Webpages are typically served by servers.

A “server”, as used herein, is generally communicatively coupled to a network, and manages network resources. A server may refer to a discrete computing device, or may refer to an application that is managing resources rather than an entire computing device. “Network”, as used herein, generally refers to a group of two or more computing devices communicatively connected to one-another. “Internet”, as used herein, generally refers to the global interconnection of computing devices, and computing device networks, commonly referred to as such.

Referring now to FIG. 1B, there is shown a block diagrammatic representation of a process 20 according to an embodiment of the present invention. According to certain embodiments of the present invention, process 20 is suitable for use at block 12 for registering a registrant. Process 20 may be utilized in combination with a database, such as the database referenced with regard to FIG. 1A.

Process 20 generally includes storing registrant contact information at block 21. Information stored at block 21 may include name, address, e-mail address, phone number and/or business type, all by way of non-limiting example.

Process 20 generally includes storing registrant preference information at block 23. In the illustrated embodiment of FIG. 1B, the preference information stored at block 23 is reflective of the registrant's preferences and contact information regarding short messaging service (SMS) messages. Information stored at block 23 may include an indication of whether the registrant wishes to receive SMS notifications of chat requests and SMS contact information for the registrant, both by way of non-limiting example. Such SMS contact information may be authenticated by sending an SMS message to the entered SMS contact address, and requiring the registrant to return and/or reply to the message.

Process 20 generally includes storing registrant preference information at block 25. In the illustrated embodiment of FIG. 1B, the preference information stored at block 25 is reflective of the registrant's preferences and contact information regarding e-mail messaging. Information stored at block 25 may include an indication of whether the user wishes to receive e-mail notifications of chat requests and e-mail contact information for the registrant, both by way of non-limiting example. Such email contact information may be authenticated by sending an email message to the entered e-mail contact address, and requiring the registrant to return and/or reply to the message.

Process 20 generally includes storing registrant information at block 27. In the illustrated embodiment of FIG. 1B, information stored at block 27 is reflective of the registrant's billing information. Information stored at block 27 may include credit card or other payment information, by way of non-limiting example.

Process 20 generally includes storing registrant information at block 29. In the illustrated embodiment of FIG. 1B, information stored at block 29 may be reflective of business, product or other registrant information, for example.

In certain embodiments of the present invention, information stored via process 20 may be stored in one or more databases, for example. Other types of information may be stored in addition to or lieu of those types discussed herein.

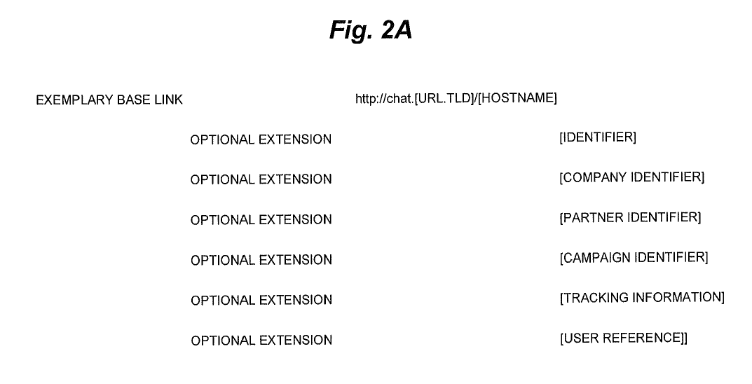

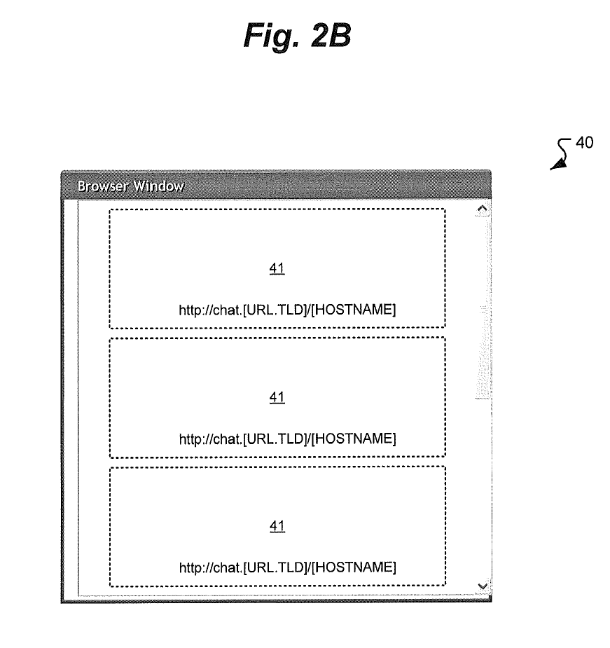

Referring now to FIG. 2A, there are shown link formats according to embodiments of the present invention. According to certain embodiments of the present invention, a link format utilized may take the form of a uniform resource locator (URL) link. Utilized links may include a base link portion. An exemplary base link portion may take the form of HTTP://[URL.TLD]/[IDENTIFIER] or HTTP://CHAT.[URL.TLD]/[IDENTIFIER], by way of non-limiting example, where URL.TLD takes the form of a conventional Internet uniform resource locator and top level domain name, and IDENTIFIER takes the form of any applicable protocol supported identification, such as an alphabetic, alphanumeric, symbolic or numeric identifier associated with the link registrant, for example. An exemplary URL.TLD may take the form of LIVECHIME.COM, for example. An exemplary IDENTIFIER may take the form of ABC123, for example. An exemplary base link portion may take the form of HTTP://LIVECHIME.COM/ABC123 or HTTP://CHAT.LIVECHIME.COM/ABC123, for example. Such base link portions may be used by themselves as links, or be supplemented with one or more extension portions.

Referring still to FIG. 2A, a link format utilized may additionally include one or more extension portions. In the illustrated case of FIG. 2A, extension(s) utilized may include one or more additional identifiers, such as a user or company identifier, a partner identifier, and/or a campaign identifier. Other extensions utilized may reflect other information, such as tracking information and/or a registrant reference, for example. In certain embodiments of the present invention, one or more extension portions may be contiguously appended to the base link portion. By way of non-limiting example, utilized links may take the form of http://livechime.com/ABC123/IDENTIFIER1 or http://livechime.com/ABC123/IDENTIFIER1/IDENTIFIER2.

Referring still to FIGS. 1A and 2A, in certain embodiments of the present invention, links may be associated with registrants at block 14 (FIG. 1) by storing the link, or portions thereof, in one or more databases so as to be associated with corresponding registrants, for example.

In certain embodiments of the present invention, links which are associated with registrants may be provided for use by prospective chat requesters, or requesters for non-limiting purposes of explanation. For example, links may be incorporated in webpages or e-mails. In certain embodiments of the present invention, registrant associated links may be incorporated in electronic classified advertisements, such as those akin to eBay or Craigslist listings, for example. Additionally, or in lieu thereof, registrant associated links may be further associated with content that is delivered to a webpage viewer, for example. In certain embodiments of the present invention, registrant associated links may be associated with particular portions of a webpage, such as individual listings on an auction or electronic-classified page, as opposed to the entire page.

Referring now to FIG. 2B, there is shown an electronic document 40 according to an embodiment of the present invention. In certain embodiments of the present invention, document 40 may take the form of a web page. Document 40 may be static and/or dynamically generated. In certain embodiments of the present invention, document 40 may include one or more web frames or windows. In certain embodiments of the present invention, document 40 may be in a web frame or window. In the illustrated embodiment, document 40 includes content 41A, 41B, 41C and links 42A, 42B, 42C. In certain embodiments of the present invention, links 42A, 42B, 42C may correspond to the links discussed regarding FIG. 2A.

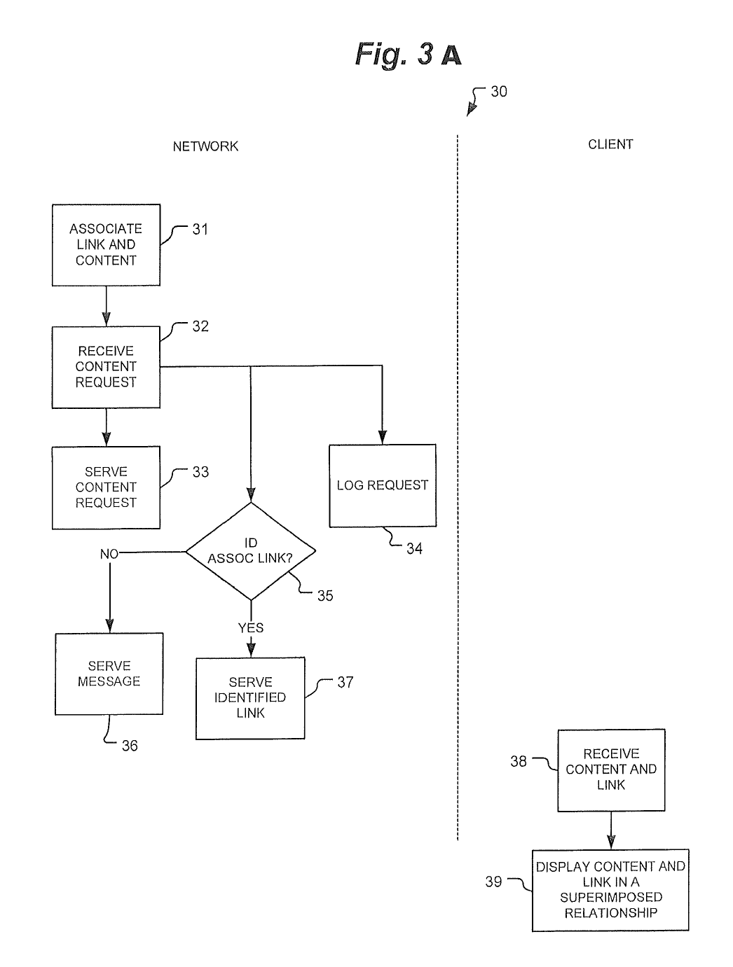

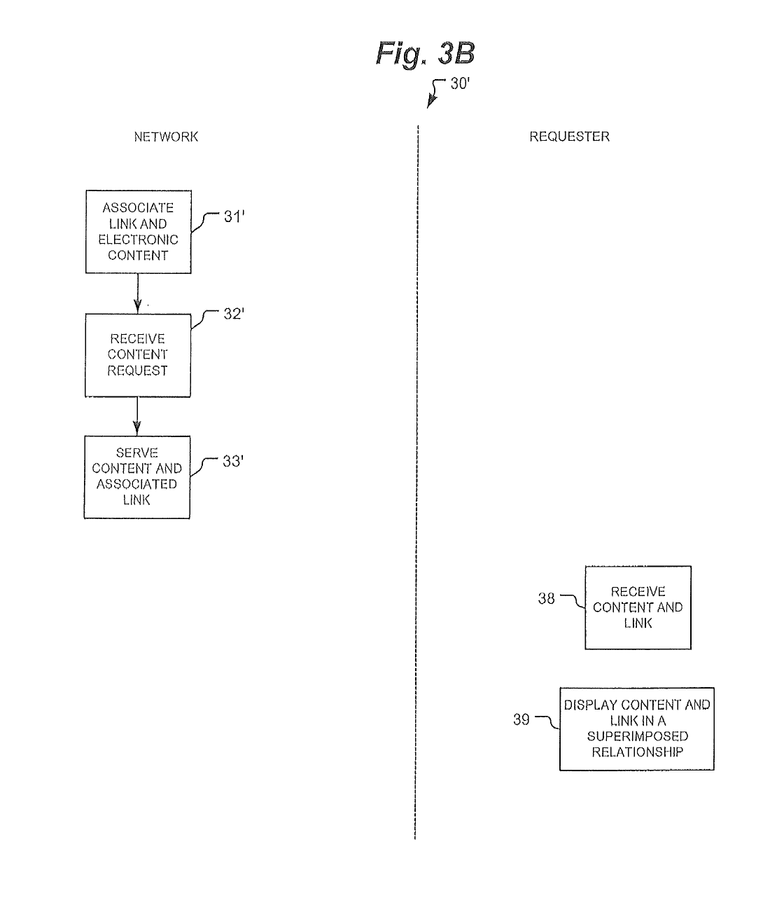

Referring now to FIG. 3A, there is shown a block diagrammatic representation of a process 30 according to an embodiment of the present invention. In certain embodiments of the present invention, links may be associated with an electronic document, such as a webpage or content for inclusion in a webpage, like graphic component(s), textual component(s) and/or video component(s), for example, at block 31. An identifier of certain content may be associated with a link (e.g., FIG. 2) at block 31, such as by being associated in a database, for example.

At block 32, a request for an electronic document and hence content is detected, such as via a received link request, for example. The request may take the form of a webpage request for example. Alternatively, the request may correspond to a content item or component for inclusion in a webpage. Such a webpage may take the form of a webpage advertisement, for example. Such a component may take the form of an advertisement component for inclusion in a webpage.

At block 33, a server, such as that receiving a request at block 32, may serve the requested document and hence content, such as an electronic document or portion thereof, like a webpage, or a component for a webpage. At block 34, the request may be logged, such as in a database.

At block 35, it may be determined whether a valid link is associated with the request detected at block 32 (e.g., associated at block 31). In certain embodiments of the present invention, processing at block 35 may include comparing a request received at block 32 to content that was associated with links at block 31. If such a comparison indicates the requested content was not associated with a link, then a message may be served at block 36. In certain embodiments of the present invention, such as message may indicate no valid link is then associated with the requested content. If such a comparison indicates the requested content was associated with a link, then the associated link may be recovered and served at block 37 to a same entity or address as was served the associated content at block 33.

In certain embodiments of the present invention, the content served at block 33 is received at a prospective chat requester's computing device at block 38. In certain embodiments of the present invention, the requester computing device may have originated the request received at block 32. In certain embodiments of the present invention, the link served at block 37 is received at a requester computing device at block 38. In certain embodiments of the present invention, the requester computing device may have originated the request received at block 32. In certain embodiments of the present invention, the message served at block 36 may be received at a requester computing device. In certain embodiments of the present invention, the requester computing device may have originated the request received at block 32. In certain embodiments of the present invention, the content and link received at block 38 by a requester computing device may be presented thereby, such as in a web browser application. The content and link received at block 38 may be presented at block 39 in a superimposed fashion, such as in a web browser application.

Referring now to FIG. 3B, there is shown a block diagrammatic representation of a process 30′ according to an embodiment of the present invention. In certain embodiments of the present invention, links may be associated with an electronic document, such as a webpage or content for inclusion in a webpage, like graphic component(s), textual component(s) and/or video component(s), for example, at block 31′. An identifier of certain content may be associated with a link (e.g., FIG. 2) at block 31′, such as by being associated in a database, for example.

At block 32′, a request for an electronic document and hence content is detected, such as via a received link request, for example. The request may take the form of a webpage request for example. Alternatively, the request may correspond to a content item or component for inclusion in a webpage. Such a webpage may take the form of a webpage advertisement, for example. Such a component may take the form of an advertisement component for inclusion in a webpage.

At block 33′, a server, such as that receiving the request at block 32, may serve the requested document and hence content, such as an electronic document or portion thereof, like a webpage, or a component for a webpage. Processing at block 33′ may include serving requested content, such as an image file, and an associated link, e.g., URL. Processing at blocks 38 and 39 is analogous to that described with regard to FIG. 3A.

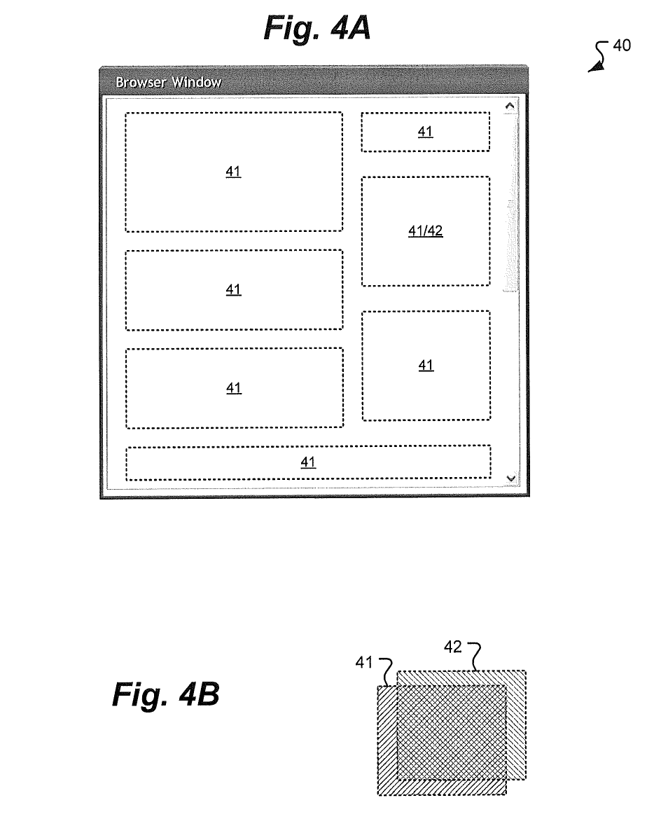

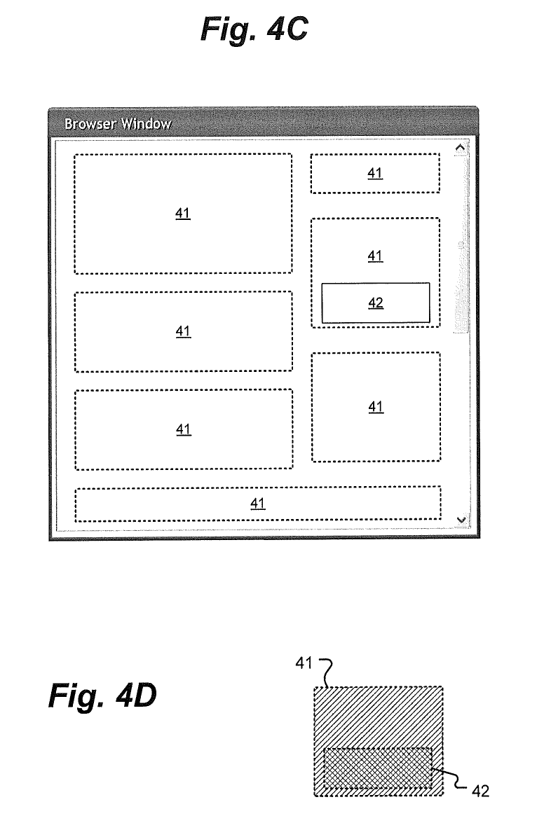

Referring now to FIG. 4A, there is shown an electronic document 40 according to an embodiment of the present invention. In certain embodiments of the present invention, document 40 may take the form of a web page. In certain embodiments of the present invention, document 40 may include one or more web frames or windows. In certain embodiments of the present invention, document 40 may be in a web frame or window. In the illustrated embodiment, document 40 includes content 41. Document 40 may be static and/or dynamically generated. In the illustrated embodiment, document 40 also includes a link 42. In the illustrated embodiment, link 42 is superimposed (e.g., spatially coincident with) substantially only with an element of content 41. Referring now to FIG. 4B, there is shown a non-limiting example of the superimposition of content element 41 and a link 42 demonstrated in FIG. 4A. While the embodiments of FIGS. 4A and 4B illustrate a link 42 and content element 41 having an at least substantially congruous size and shape, either may differ from that of the other. In certain embodiments of the present invention, content 41 and link 42 may take the form of an embedded image (e.g., <img> tagged item) wrapped by an anchor tag, e.g., an <a> tag.

Referring now to FIG. 4C, there is shown an electronic document 40 according to an embodiment of the present invention. In certain embodiments of the present invention, document 40 may take the form of a web page. In certain embodiments of the present invention, document 40 may include one or more web frames or windows. In certain embodiments of the present invention, document 40 may be in a web frame or window. In the illustrated embodiment, document 40 includes content 41. Document 40 may be static and/or dynamically generated. In the illustrated embodiment, document 40 also includes a link 42. In the illustrated embodiment, link 42 is superimposed substantially only with a portion of (e.g., incorporated within the space of) an element of content 41. Referring now to FIG. 4D, there is shown a non-limiting example of the superimposition of content element 41 and a link 42 demonstrated in FIG. 4C. The embodiments of FIGS. 4C and 4D illustrate a link 42 and content element 41 having different shapes and sizes from one another. Again, anchor tagging may be used.

In certain embodiments of the present invention, link activation at a registrant's computing device may selectively trigger a chat initiation with a registrant associated with the activated link. A link may be activated by a requester selecting it, rolling a pointer over it, or upon the launching, loading or displaying of an electronic document that includes it, for example.

As will be understood by those possessing an ordinary skill in the pertinent arts, one or more components of an electronic document, e.g., content 41, may correspond to electronic document “real-estate”. An image to be placed in this real-estate, e.g., as content 41, may be pulled from a given storage location when the electronic document is requested, for example. Additionally, a link associated with the content, e.g., 42, may be analogously pulled. Alternatively, the electronic document may itself include code that pulls such an image file and/or link, e.g., URL.

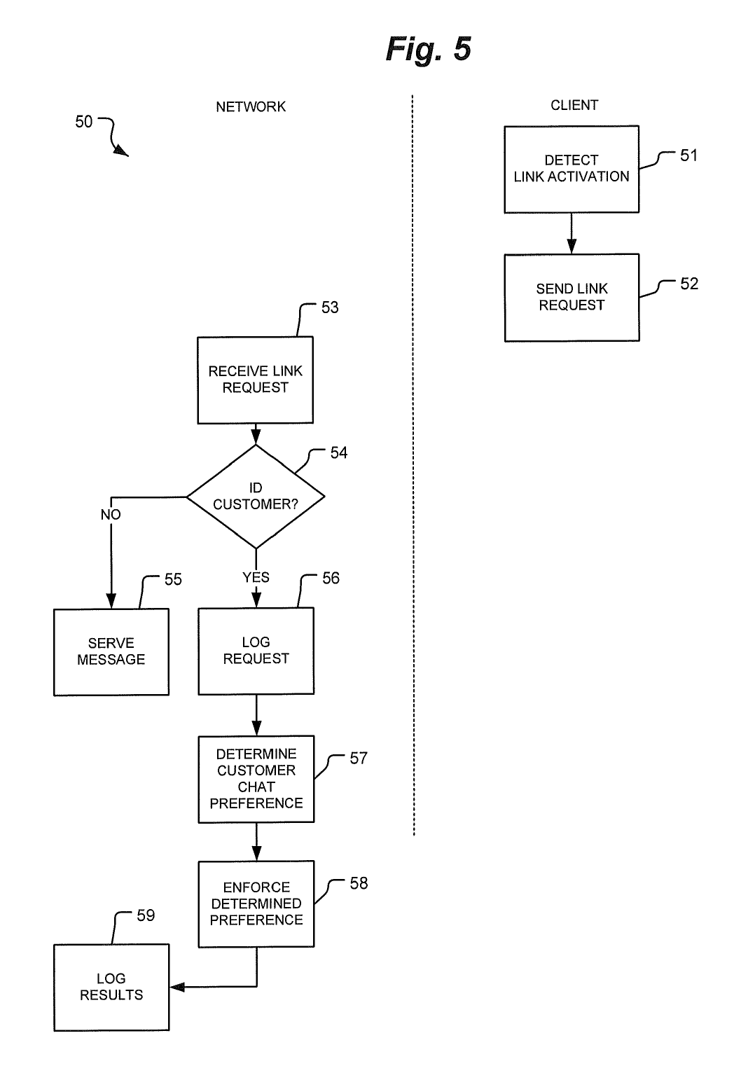

Referring now to FIG. 5, there is shown a block diagrammatic representation of a process 50 according to an embodiment of the present invention. In the illustrated embodiment, process 50 includes detecting a link activation at block 51. Processing at block 51 may include detecting a requester activation of a link within a web browsing or other computing device application, such as a link discussed in connection with FIG. 2A. Processing at block 51 may include detecting a requester activation of a link within a browsing or other computing device application, such as a link served at block 37 (FIG. 3). Processing at block 51 may include detecting a requester activation of a link within a browsing or other computing device application, such as a link 42 discussed in connection with FIGS. 4A-4D. At block 52, a message, such as an electronic document (e.g., web page or other page) or content request may be sent by the requester's computing device, responsively to the link activation detection at block 51.

Referring still to FIG. 5, at block 53 a request corresponding to a link is received. The request received at block 53 may correspond to the request sent at block 52. At block 54, it is determined whether a valid registrant is associated with the request received at block 53. Processing at block 54 may include parsing the request received at block 53. Processing at block 54 may include comparing portion(s) of the request received at block 53 to information corresponding to registrant, such as one or more pieces of information entered or stored using process 20 (FIG. 1B). Processing at block 54 may include determining whether a link which was activated is active or inactive. Active links may be associated with chat requests that should be allowed to mature into chat sessions, while inactive links may be associated with chat requests that should be denied or rejected. Data flags may be stored in one or more databases to indicate whether an activated link is active or inactive. Link requests and comparison results may be logged at block 56, such as in a database, for example.

In certain embodiments of the present invention, chat request logs may indicate referring web pages or websites from which the received and logged chat requests originate. Such a feature may enable registrants to track or audit how different links, and hence associated advertisements, are performing. For example, a real estate agent may place a listing on three different websites. A same chat link corresponding to the listing may be used in all three listings. Logged chat requests may provide such a real estate agent to readily ascertain how different ones of the listings are performing, relative to one-another, by comparing how many chat requests are originating from each of the web pages, for example. In such a case, cross-website advertisement performance may be more readily available than is conventionally possible, for example.

By way of further, non-limiting example, Table-1 illustrates a chat request log that may be presented in an interactive electronic document, e.g., a web page, according to an embodiment of the present invention. Each row of the illustrated Table-1 is indicative of and associated with a specific chat request. Each row includes an indicator of whether the chat was answered or missed/declines; the date and time of the request, the subject of the request, and an indication of the chat requester, such as a name or e-mail address. Data indicative of that included in Table-1 may be mined from and automatically stored responsively to chat requests in a database, which may be automatically queried to generate Table-1 for a registrant, for example.

TABLE 1

| Answered/Missed | Date/Time | Subject | From |
|---|---|---|---|
| ✓ | YYYY/MM/DD | Item 1 | Requester 1 |
| | HH:MM | | |
| x | YYYY/MM/DD | Item 2 | Requester 2 |
| | HH:MM | | |
| ✓ | YYYY/MM/DD | Item 1 | Requester 3 |
| | HH:MM | | |

By way of further, non-limiting example, Table-2 illustrates a chat request log that may be presented in an interactive electronic document, e.g., a web page, according to an embodiment of the present invention. Each row of the illustrated Table-2 is indicative of a different link/link location that is associated with a registrant. Each row includes an indicator of whether chat requests associated with the link are being handled in accordance with global or custom preferences; an indicator of whether action is to be taken when chat requests associated with the link are received; what type of chat request notifications are associated with the link; indications of what electronic document(s) (e.g., website) the link is being used on or with; keywords the link registrant has chosen to indicate the link; and, the number of chat requests, e.g., hits, associated with the link that have been received. Table-2 additionally includes edit and delete items, which can be used to change the preferences or other link settings or delete the link, respectively. Data indicative of that included in Table-2 may be mined from and automatically stored responsively to chat requests in a database, which may be automatically queried to generate Table-2 for a registrant, for example.

TABLE 2

| Custom | | Notifi- | | Key- | | | |
|---|---|---|---|---|---|---|---|
| Setting | Action | cation | Web Site | words | Hits | | |
| x | Active | email | Auction | Item 1 | 1 | <edit> | <del> |
| | | | site 1 | | | | |
| x | Active | SMS | Classifieds | Item 1 | 1 | <edit> | <del> |
| | | | Site 1 | | | | |
| x | Active | SMS/ | Classifieds | Item 2 | 1 | <edit> | <del> |
| | | email | Site 2 | | | | |

In certain embodiments of the present invention, multiple rows that are indicative of and associated with a common link may be provided in Table-2. In such a case, each of the common link associated rows may be associated with a different electronic document (e.g., website), which referred the indicated hits. Again, data indicative of that included in such a Table-2 may be mined from and automatically stored responsively to chat requests in a database, which may be automatically queried to generate Table-2 for a registrant, for example.

By way of further, non-limiting example, Table-3 illustrates a chat request log that may be presented in an interactive electronic document, e.g., a web page, according to an embodiment of the present invention. Each row of the illustrated Table-3 is indicative of a different link/link location that is associated with a registrant. Each row includes an indicator of the date and time of a given record; the type of offer(s) with each record, namely, for example, what message, format and/or information is being used to generate requests for the chats; each users name; each users email address; the type of subscription associated with each user; the date and time of the last login for that given record; the number of requests for chat associated with the given offer for the given user; and the number of chats resulting from the foregoing. Table-3 additionally includes edit and delete items that can be used to change the preferences or other link settings or delete the link, respectively. Table-3 additionally includes options allowing the addition of new records, refreshing records and features permitting drilling down into the information contained within certain records within each row item. For example, there are buttons in the row just underneath the “Date,” “Offer,” and other items, such as the buttons in the “Offer” column (“_” in which search items may be inserted and the “¥” button which when activated instantiates further screens of information) that allow an administrator and/or registrant to review a specified offer “x,” its content, format and/or other information that is desirous of being tracked and/or audited. Registrants, users and/or administrators may therefore be able to readily ascertain which “Offers” are performing best. Data indicative of that included in Table-3 may be mined from and automatically stored responsively to chat requests in a database, which may be automatically queried to generate Table-3 for a registrant, for example.

TABLE 3

| + Add new record | | | | | | | Refresh | |
|---|---|---|---|---|---|---|---|---|
| << 1 2 3 4 5 6 7 8 9 10 . . . >> | | | | | | | | |
| | | User | Page of xx Go | Page Size Change | | Item 1 of 25 of 999 | | |
| Date | Offer | Name | Email | Type | Last Login | Requests | Chats | |
| | ¥ | ¥ | ¥ | ¥ | | | | |
| YYYY/MM/DD | x | user1 | user1 email | Trial | YYYY/MM/DD | 100 | 30 | Edit/ |
| HH:MM | | | | | HH:MM | | | Delete |
| YYYY/MM/DD | y | user2 | user2 email | Pro | YYYY/MM/DD | 275 | 125 | Edit/ |
| HH:MM | | | | | HH:MM | | | Delete |
| YYYY/MM/DD | z | user3 | user3 email | Level | YYYY/MM/DD | 50 | 15 | Edit/ |
| HH:MM | | | | N | HH:MM | | | Delete |

In certain embodiments of the present invention, multiple rows that are indicative of and associated with a common link may be provided in Table-3. In such a case, each of the common link associated rows may be associated with a different electronic document (e.g., website), which referred the indicated hits. Again, data indicative of that included in such a Table-3 may be mined from and automatically stored responsively to chat requests in a database, which may be automatically queried to generate Table-3 for a registrant, for example.

In certain embodiments of the present invention, certain listings may expire. For example, advertisement listings on electronics classifieds websites may automatically expire after a given amount of time, e.g., 30, 60 or 90 days after listing. Certain embodiments of the present invention may be supplemented with an automatic relisting feature. For example, code that is operated at a server and automates re-listing of an advertisement with the included link may be provided to provide for link provision continuity. In such case, advertisement tracking may be automatically enhanced in duration as well.

In certain embodiments of the present invention, an image used in association with a link as discussed herein may be used to count the number of times the image has been loaded, such as by a web browser application. For example, a program may be executed at a server each time the image file is requested. In certain embodiments of the present invention, this information may be used in conjunction with that illustrated in Tables 1 and 2 to indicate a how effective the image and link are at generating actual chat requests, since the number of times an opportunity for a chat has been presented to potential requesters is known, and the number of actual chat requests received is also known. This may further assist registrants to judge the relative effectiveness of different web-pages as chat request sources for example. In certain embodiments of the present invention, Table-2 may be appended to include an indication in each row indicative of this number of times an image has been requested, and hence the number of times the indicated chat link has been presented for use to potential requesters as well. In certain embodiments of the present invention, Table-2 may be appended to include an indication of how effective a referral source is in generating quality leads, such as by considering a number of times an image has been requested, and hence the number of times the indicated chat link has been presented for use to potential requesters, as well as the number of chat requests that were actually received. Such an image may take the form of one or more pixels, for example.

The first version simply places an image at the current location and justifies any text to line up with the bottom of the image. The second version allows you to specify where you would like the text to be placed. The alignment option can be either “top” or “middle”. By specifying a URL for the image, an executable program can be specified.

Referring still to FIG. 5, if a comparison at block 54 indicates the requested content is not associated with a registrant, or is otherwise not valid, a message may be served at block 55. In certain embodiments of the present invention, such as message may indicate no valid registrant is then associated with the requested link, or that a chat is not possible at this time. If such a comparison indicates the requested link is associated with a registrant, and is otherwise valid, processing may continue at block 57.

At block 57, the associated registrant's chat preferences may be determined. In certain embodiments of the present invention, processing at block 57 may include recovering one or more pieces of information entered or stored using process 20 (FIG. 1B). For example, processing at block 57 may include recovering SMS and/or e-mail preference information entered at blocks 23, 25 (FIG. 1B). Such information may indicate whether the associated registrant wishes to receive an SMS message indicating a link associated with him has been activated. Such information may indicate whether the associated registrant wishes to receive an e-mail message indicating a link associated with him/her has been activated.

At block 58, the preference(s) determined at block 57 may be enforced, such as by selectively sending either an SMS and/or an e-mail message indicative of the activated link dependently upon the determining at block 57. At block 59, preference enforcement at block 58 may be logged, such as in a database, for example.

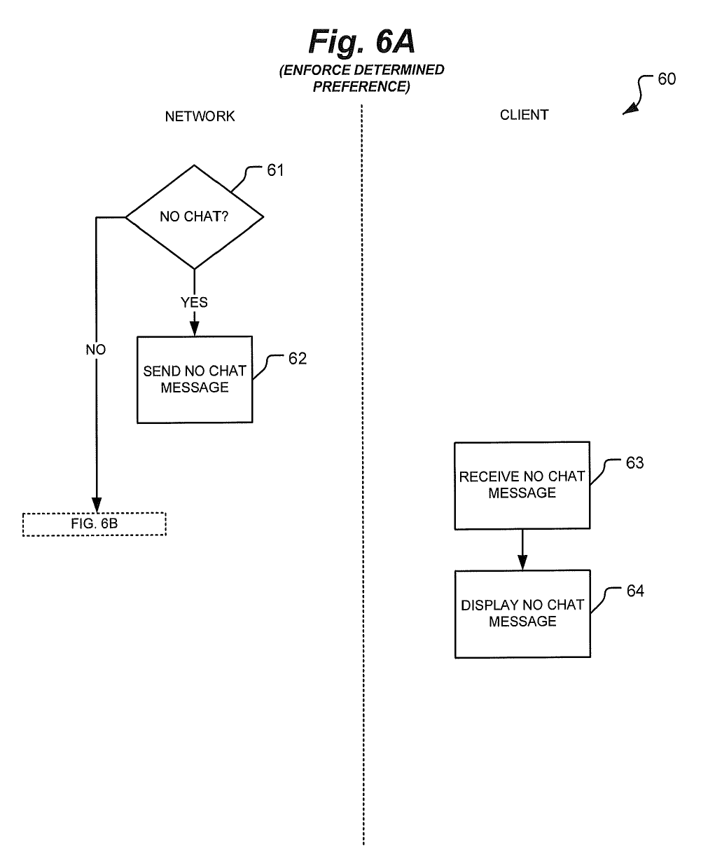

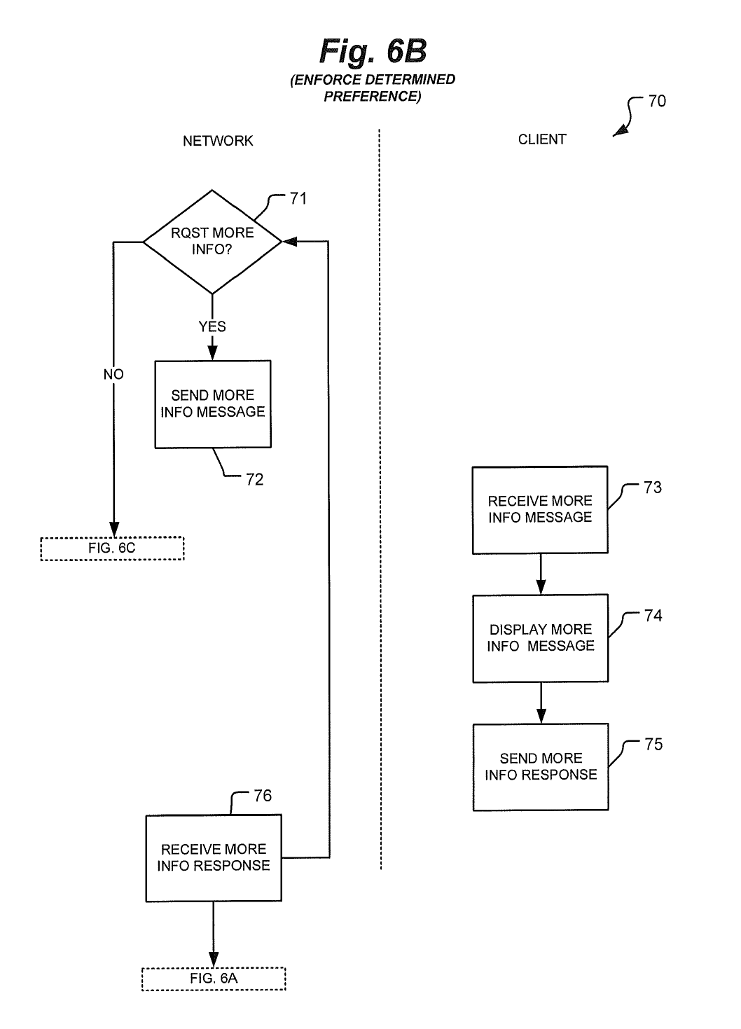

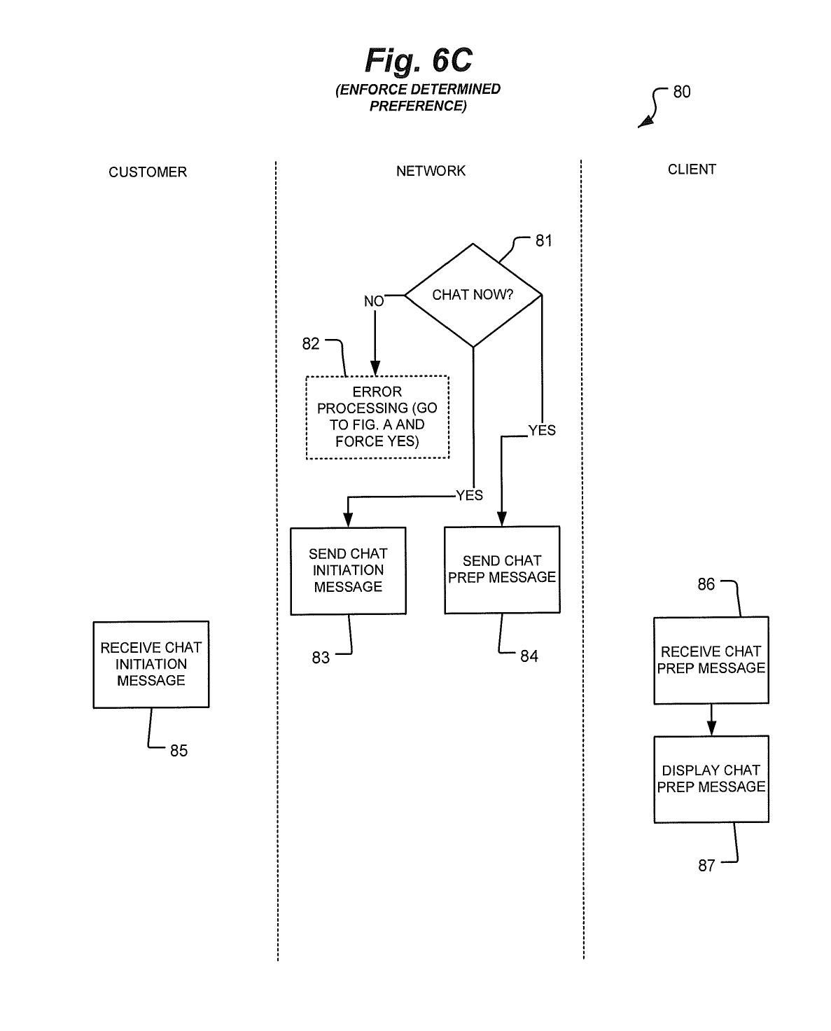

Referring now to FIG. 6A, there is shown a block diagrammatic representation of a process 60 according to an embodiment of the present invention. In certain embodiments of the present invention, process 60 is well suited for use as at least part of process 58 (FIG. 5). Process 60 begins with determining whether a chat service with the associated registrant, or his designee or proxy for example, is available, at block 61. Processing at block 61 may include determining whether a “don't chat right now” or “no chat” preference has been selected by or on behalf of the associated registrant. Processing at block 61 may include examining one or more recovered preferences-related information entered using process 20 (FIG. 1B) (e.g., at block 29), for example. If processing at block 61 indicates a no chat preference has been selected, a no chat available message may be sent at block 62. The message sent at block 62 may be sent to a requester computing device that detected link activation at block 51 (FIG. 5), for example. At block 63, the message sent at block 62 may be received by such a requester computing device. At block 64, there received message may be presented to a requester, such as via a display, for example.

Alternatively, if processing at block 61 indicates a chat may be initiated preference has been selected (e.g., no no-chat preference has been selected), processing may continue with process 70 (FIG. 6B), for example.

Referring now to FIG. 6B, there is shown a block diagrammatic representation of a process 70 according to an embodiment of the present invention. In certain embodiments of the present invention, process 70 is well suited for use as at least part of process 58 (FIG. 5). Process 70 begins with determining whether the associated registrant's preference is to request additional information at block 71. Processing at block 71 may include determining whether a “request more requester information” preference has been selected by or on behalf of the associated registrant. Processing at block 71 may include examining one or more recovered preferences-related information entered using process 20 (FIG. 1B) (e.g., at block 29), for example. If processing at block 71 indicates no more information should be requested, processing may proceed to process 80 (FIG. 6C). If processing at block 71 indicates more information should be requested, an information request message may be sent at block 72.

The message sent at block 72 may be to a requester's computing device that detected link activation at block 51. The message sent at block 72 may be received by such a computing device at block 73. The message received at block 73 may be presented to a requester at block 74, such as via display, for example. The requester may then enter the requested information and send it back to the originator of the block 72 request at block 75. Such a message is received at block 76. Processing then returns either to process 60 or block 71, for example.

Referring now to FIG. 6C, there is shown a block diagrammatic representation of a process 80 according to an embodiment of the present invention. In certain embodiments of the present invention, process 80 is well suited for use as at least part of process 58 (FIG. 5). Process 80 begins with determining whether the associated registrant wishes to enter into the requested chat with a requester. Processing at block 81 may include determining whether a “no chat now” or “away from computer” preference has been selected by or on behalf of the associated registrant. Should processing at block 81 indicate that no chat should commence, processing may return to block 62 (FIG. 6A).

Should processing at block 81 indicate a chat should commence, chat initiation messages may be sent at blocks 83, 84. The message sent at block 83 may be received at the associated registrant's computing device at block 85. The message sent at block 84 may be received at the requester's computing device at block 86. At block 87, the requester may be advised that a chat is being prepared and/or set up.

The message sent at block 83 may notify the associated registrant (as determined at block 54) that a chat is being requested and be in accordance with that registrant's preferences. For example, the registrant may have entered that they prefer SMS notifications at block 23 (FIG. 1B). In such an event, an SMS message may be sent with a chat link using the entered SMS preference information. Similarly, the registrant may have entered that they prefer e-mail notifications at block 25 (FIG. 1B). In such an event, an e-mail message may be sent with a chat link using the entered e-mail preference information.

In certain embodiments of the present invention, a chat link message may include a link, such as a URL that points to a website or invokes a web service. In certain embodiments of the present invention, a chat link message may include a substantially unique chat or session indicator, such as a Globally Unique Identifier (GUID). By way of non-limiting example, there may be a substantial number of GUIDs available, such as on the order of 2¹²⁸, for use by the system. In certain embodiments of the present invention, vanity-type identifiers may be used.

In certain embodiments of the present invention, a chat link message may include a conventional-type URL indicative of a chat application, service or administration website. Such a URL may be appended with a unique identifier, as discussed above. Upon activation of the chat link message URL, a registrant may be logged into a secure website associated with the chat application. Such a secure website may include features, elements and/or pieces of content that are automatically updated from time-to-time by the system. In certain embodiments of the present invention, such features, elements and/or pieces of content may be indicative of whether a registrant is waiting for a chat session to commence.

In certain embodiments of the present invention there may be more than one type of chat link that may be sent at block 83 and received at block 85. For example, there may be different types of chat services corresponding to different computing capabilities or properties of registrants' computing devices. For example, there may be a first type of chat link indicative of and corresponding to a chat service that is tailored for computing devices having substantial display capabilities, such as computing devices having substantial display size or resolution, and resources like personal computers. Another type of chat link that may be sent and received may be indicative of and correspond to a chat service that is tailored for computing devices having less display capabilities, such as computing devices having relatively limited display resources like smart phones. The capabilities may reflect display capabilities, and the amount of display real-estate available, for example.

By way of non-limiting, further explanation only, in certain embodiments of the present invention, one or more of the chat links may correspond to a chat application that is so-thin in design, that other computing capabilities needed, such as memory, processing, display space and/or browser application capabilities, for example, are minimized.

By way of non-limiting, further explanation only, in certain embodiments of the present invention, one or more of the chat links may correspond to a chat application that is still thin, but more computing resource intensive. Such an application may be well-suited for use with sophisticated, web-enabled devices, such as the Apple i-Phone and/or personal computers, for example. Such an application may provide for visual geographic indicators that are associated with chat requests. Such indications may be provided by a reverse-IP or DNS lookup of the chat requester, for example. Such an application may be provided with advertisement portions, for example. Such an application may monitor for chat requests, such as by proactively checking a database for entries indicative of pending chat requests. Such an application may, in certain embodiments, include a downloaded component, such as code, that may or may not be automatically launched at computing device or operating system start-up, for example. Such a component may automatically launch a browser window responsively to a new chat request being indentified, for example.

In certain embodiments of the present invention, the type of message sent at block 83 may be associated with the type(s) of link(s) sent at block 83. For example, an e-mail notification sent at block 83 may include one or both types of chat links, as it may typically be accessed using a variety of types of computing devices having various computing capabilities and resources, such as display size. In contrast, an SMS notification sent at block 83 may include only the reduced computing dependent types of chat links, as it may typically be accessed using computing devices having relatively limited display sizes.

Such an approach may advantageously provide for robust chat application provision that is operable in a greater variety of scenarios than conventional chat applications.

By way of further, non-limiting explanation, certain embodiments of the present invention may be particularly well-suited for use by/with amateur seller registrants or registrants having relatively limited computing and/or financial resources. Such registrants may not be able/willing to provide an amount of monitoring for chat services as may conventionally be required. For example, a listing agent for real estate or an e-commerce classifieds seller cannot/will not typically continuously monitor their office or home office personal computer for chat requests—resulting in missed sales opportunities, relative to a competitor that staffs or otherwise retains a conventional call center, for example. This may result is substantial commercial disadvantage.

Further, while such a registrant may be able to monitor electronic communications, such as e-mails, using a plurality of computing devices, such as personal computers and Internet enabled cell phones and PDAs, these devices have substantially different processing capabilities. Accordingly, if a conventional chat application is enhanced, so as to take advantage of the substantial resources available on a modern-day personal computer, the application may prove to be unwieldy, poor functioning or even incompatible with cellular phones or PDAs. On the other hand, if a conventional chat application is adapted to the lowest common denominator of capabilities, an enhanced experience that takes advantage of the substantial resources available on a modern-day personal computer is not available for a registrant. Accordingly, conventional chat applications may not be well suited for use by/with amateur seller registrants or registrants having relatively limited computing and/or financial resources.

In contrast, embodiments of the present invention provide for a selectively enhanced, chat-anywhere-type functionality, such that: (1) registrants do not need to continuously monitor for chat requests, and chat requests may be “pushed” to them or automatically “pulled” for them; and (2) chat application instantiations are adapted based upon the capabilities (or expected capabilities) of the registrant's computing device. For example, a relatively less-computing resource intensive, mobile-device-type adapted chat application may be provided for use with mobile devices. And, an enhanced, relatively more-computing resource intensive, personal computer-type device adapted chat application may be provided for use with such devices.

Differences between the chat application instantiations may include the frequency and type of additional content. A PC-type chat instantiation may include animated or video content, and additional resource information, such as graphic or other information. This other information may be associated with the chat instantiation or subject, for example. By way of further example, a Google® mapping corresponding to the IP address of the chat requester may be provided, for example. Such information may help a registrant determine whether or not to accept a communicated chat request, by letting him/her know the relative proximity of the requester to a location of interest, such as the location of an item or service for sale, for example. Additional information about other chats may also be provided, such as other chats by that client or other chats about the subject, for example. A mobile device-type chat instantiation may omit such additional information, effectively saving the limited display real-estate for the chat itself, for example.

In certain embodiments of the present invention such a selectively enhanced, chat-anywhere-type functionality may be provided using a plurality of links (e.g., as part of the message sent at block 83 in FIG. 6C). Each of the links may correspond to a different type of chat instantiation. The type of chat application instantiated may be based upon which link a registrant activates. For example, one link may be identified as a mobile device-type link, while another is identified as a PC device-type link. The mobile device-type one of the links may correspond to, and cause to be launched upon activation there of, a mobile device-type chat application instantiation. Similarly, the PC-type one of the links may correspond to, and cause to be launched upon activation there of, a PC-type chat application instantiation. Thus, enhanced chat services may be provided, while providing for mobile device adapted chat services.

Depending upon registrant preferences (e.g., whether e-mail or SMS chat notification is to be used), one or more of the links may be sent. For example, if SMS messaging is used, only the mobile device-type link may be sent. If e-mail messaging is to be used, one or more of the links may be provided. If the registrant has indicated that he doesn't wish to use mobile chat support, than only the PC-type link may be provided, for example.

In certain embodiments of the present invention, which type of chat application instantiation is launched may be automatically determined, such as based upon a type of computing device or computing device application which originated a response to a chat initiation message (e.g., the message sent at block 83 of FIG. 6). For example, a type of browser used to accept a chat request (e.g., by activating a provided link) may be automatically determined in a conventional manner, such as by serving an electronic document that can be used to gather information regarding the browser or computing device in a conventional manner. If the gathered information is indicative of a mobile-type device, a mobile device-type chat instantiation may be used. If the gathered information is indicative of a PC-type device, a PC device-type chat instantiation may be used.

In certain embodiments of the present invention, processing at block 81 may further include determining whether the registrant corresponding to the chat request being processed is logged on to a chat application, such as by being logged onto a chat associated server in a conventional manner. If the registrant is logged on, processing may continue at blocks 83 and 84, for example.

In certain embodiments of the present invention, if a chat has not commenced within a given amount of time after blocks 83, 84, an updated message to the chat requester may be provided at blocks 86, 87. Such a message may present the requester with an opportunity to cancel the chat request or continue waiting. If the requester opts to cancel the request, or otherwise fails to respond thereto, processing may cease. If the requester opts to continue waiting, a timer may be restarted for further analogous processing for example. Referring still to FIG. 6C, processing at blocks 86 and 87 may include periodically requesting an asynchronous or AJAX type update for an electronic document responsively, such as a responsively to a JAVA script-type timer application.

Referring still to FIG. 6C, processing at blocks 86 and 87 may include periodically requesting an asynchronous or AJAX type update for an electronic document responsively, such as a responsively to a JAVA script-type timer application.

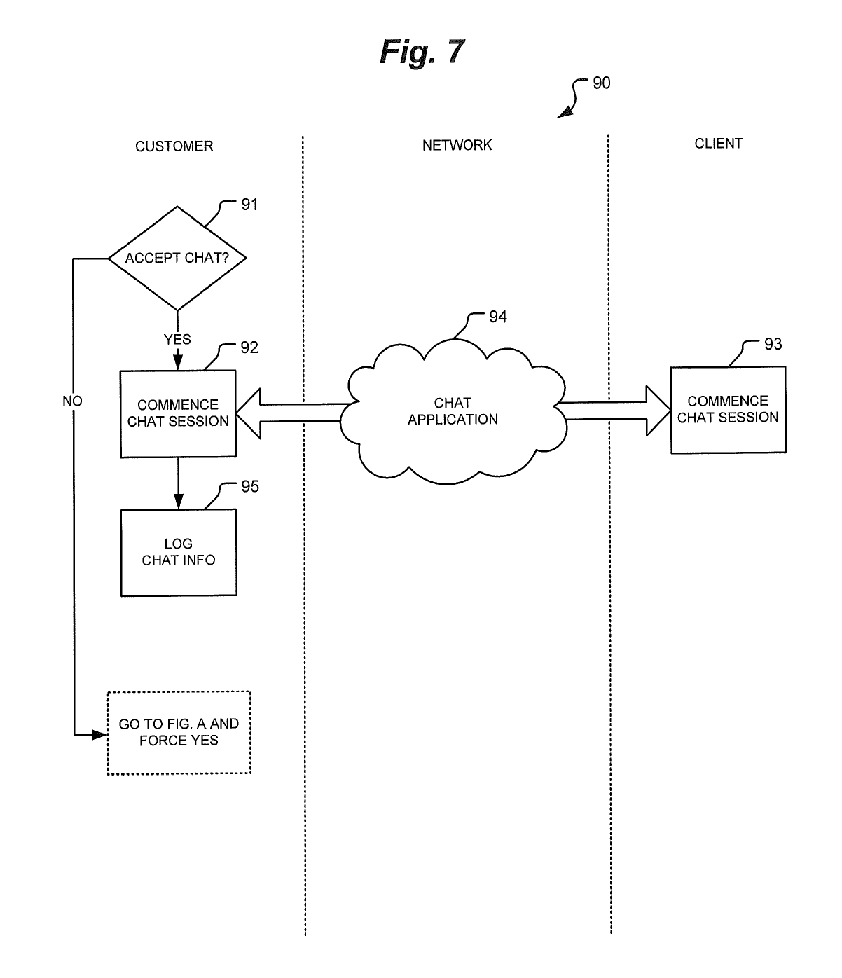

Referring now to FIG. 7, there is shown a block diagrammatic representation of a process 90 according to an embodiment of the present invention. Process 90 begins with a registrant user deciding whether or not to accept a chat request at block 91. Processing at block 91 may include updating features, elements and/or pieces of content on the logged in, secure website indicating a registrant is waiting for a chat, along with one or more links that allow the registrant to accept or decline that chat. The secure website may correspond to the type of chat link sent at block 83, such that multiple website configurations may be used depending on the type of chat link received at block 85 and which was activated.

If processing at block 91, e.g., a registrant's interaction with the one or more links that allow the registrant to accept or decline that chat, indicates the registrant user does not wish to engage in the requested chat, processing may proceed to block 62 (FIG. 6A). If processing at block 91 indicates the registrant does wish to engage in the requested chat, a chat application 94 is commenced at blocks 92, 93. The chat occurrence is logged at block 95, such as in a database.

Chat application 94 commencement at block 92 may include automatically updating the logged into, and secure website viewed by a registrant (or a portion thereof) to include content indicative of chat exchanges (e.g., text and/or other content exchanged with the requester). Chat application 94 commencement at block 93 may include directing, or redirecting, the requester's computing device to an electronic document (e.g., web page) that includes a content portion indicative of chat exchanges (e.g., text exchanged with the chat accepting registrant).

Referring still to FIG. 6C, processing at blocks 92 and 94 may include periodically requesting an asynchronous or AJAX type update for an electronic document responsively, such as a responsively to a JAVA script-type timer application.

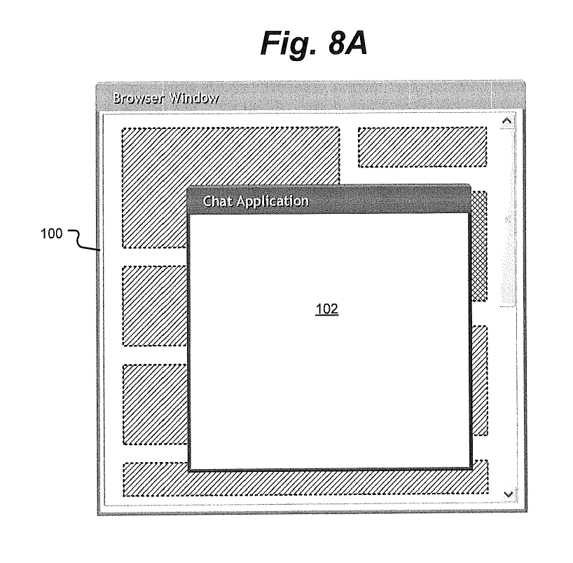

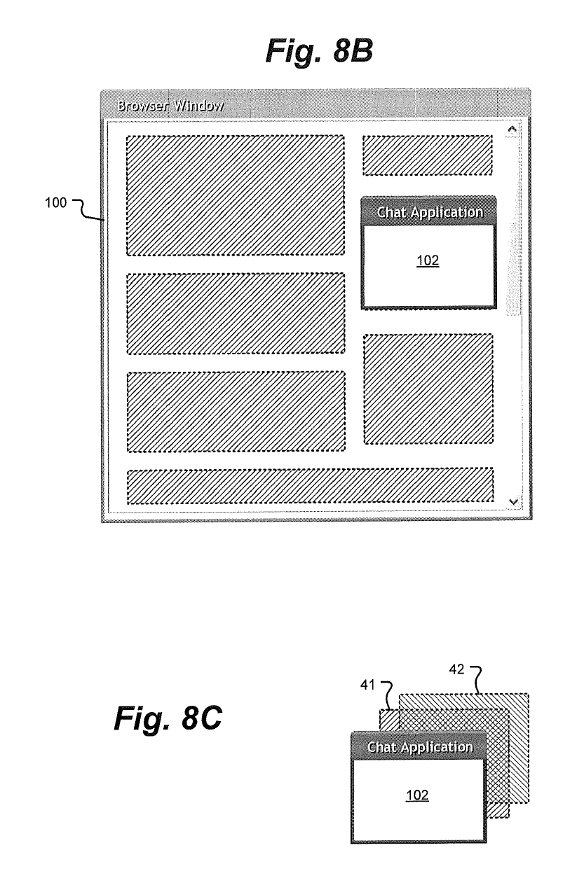

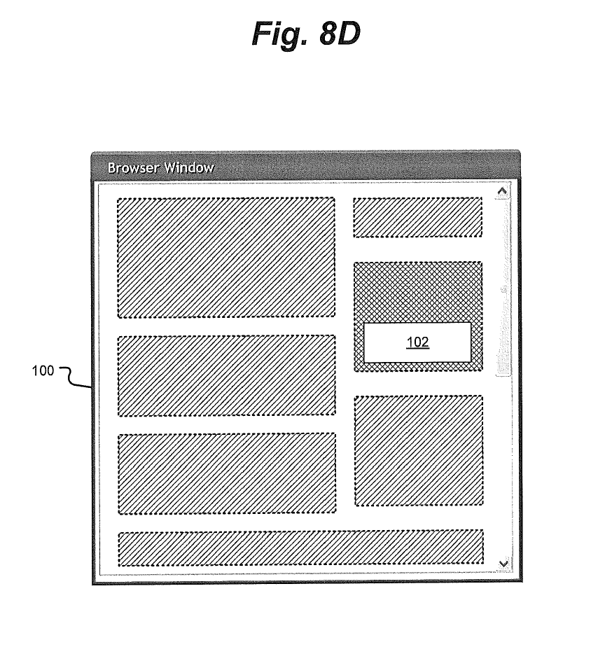

Referring now to FIG. 8A, there is shown an electronic document 100 and chat application instantiation 102 for a requester's computing device according to an embodiment of the present invention. Chat application instantiation 102 may correspond to chat application 94 (FIG. 7). In the illustrated embodiment, instantiation 102 is in the form of a separate window from electronic document 100. In certain embodiments of the present invention, document 100 may take the form of any of documents 40 (FIGS. 4A and 4C), for example. In certain embodiments of the present invention, document 100 may take the form of a framed document 40 (FIGS. 4A and 4C), for example. In certain embodiments of the present invention, received messages, such as those served at blocks 36, 55, 62, 72 and/or 84, and/or received at blocks 63, 73 or 86, for example, may be presented via a requester's computing device in another frame or window from an electronic document, such as document 40 or 100.

In certain embodiments of the present invention, the instantiation 102 window may be substantially identical in size, shape and/or content to electronic document 100 rather than substantially only a corresponding portion of the overall content presented therein. After a user is finished interacting with the instantiation 102 window, the display may be returned to electronic document 100. Such a configuration may advantageously have the chat appear more integrated to a requester than conventional chat applications, which may lead to greater acceptance and use thereof by potential requesters. In certain embodiments of the present invention the instantiation 102 window may take the form of the electronic document 100 window being framed and including the chat instantiation.

Referring now to FIG. 8B, there is shown an electronic document 100 and chat application instantiation 102 for a requester's computing device according to an embodiment of the present invention. Chat application instantiation 102 may correspond to chat application 94 (FIG. 7). In the illustrated embodiment, instantiation 102 is in the form of a separate window from electronic document 100, which window is superimposed substantially only with the link associated content of document 100.

Referring now to FIG. 8C, there is shown a non-limiting example of a superimposition of chat application instantiation 102, content element 41 and a link 42 consistent with FIG. 8B. The embodiment of FIG. 8C illustrates a chat application instantiation 102 window, link 42 and content element 41 having analogous shapes and sizes as one another, although other configurations may be used. In the illustrated embodiment, instantiation 102 is in the form of a separate window from electronic document 100, which window is superimposed with and at least substantially the same size and shape as the link associated content of document 100. Such a configuration may advantageously allow the chat window to be better associated with the document 100 to a requester, possibly leading to greater acceptance and usage of chat applications by such users.

Referring now to FIG. 8D, there is shown an electronic document 100 and chat application instantiation 102 for a requester's computing device according to an embodiment of the present invention. Chat application instantiation 102 may correspond to chat application 94 (FIG. 7). In the illustrated embodiment of FIG. 8D, chat application instantiation 102 is in a same window as document 40, forming a portion thereof. In certain embodiments of the present invention, a portion of the link associated content may be replaced with the chat application presentation upon instantiation of a chat. By way of further non-limiting example, in certain embodiments of the present invention an embedded floating frame may be used in conjunction with Active Server Page Framework (ASPX) functionality to enable the chat application to be updated independently from at least one other portion and/or the remainder of document 100. In certain embodiments of the present invention, asynchronous postbacks may be used to enable the chat application to be updated independently from at least one other portion and/or the remainder of document 100. In certain embodiments of the present invention, an AJAX approach that uses asynchronous JavaScript and XML may be used to enable the chat application to be updated independently from at least one other portion and/or the remainder of document 100. Again, instantiation 102 is substantially only superimposed with link 42 associated content 41.

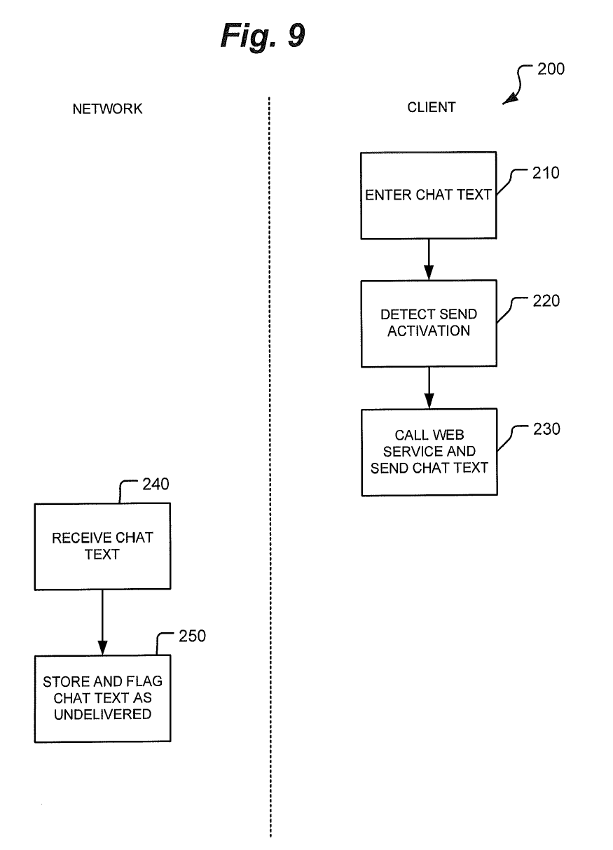

Referring now to FIG. 9, there is shown a block diagrammatic representation of a process 200 according to an embodiment of the present invention. In certain embodiments of the present invention, process 200 is well suited for use as at least part of chat application 94 commenced at blocks 92, 93 (FIG. 7).

At block 210, a first of the registrant/requester's computing device users enters text for the chat application using an electronic document or website. At block 220, a user activated “send” text link or object, such as a button, activation is detected. At block 230 a server or web service corresponding to the chat application 94 (FIG. 7) is called responsively to the detection at block 220. The server or web service may call one or more chat application 94 related procedures, for example. The server or web service procedures may receive the text entered at block 210 at block 240, responsively to it being sent at block 230. The server or web service procedures may store the text received at block 240 in a database, such as a Structured Query Language (SQL)-type database corresponding to the chat application 94 (FIG. 7). Additional information associated with the text stored at block 250, such as an associated chat session identifier, originating user, destination user and/or delivery status (e.g., delivered or undelivered) indicator may also be stored, such as in the SQL database.

Such a processing may allow for a stateless chat instantiation that includes a queue of unresolved communications, such as chat requests and chat messages. Such communications may be pushed, or pulled using asynchronous requests to resolve the communications.

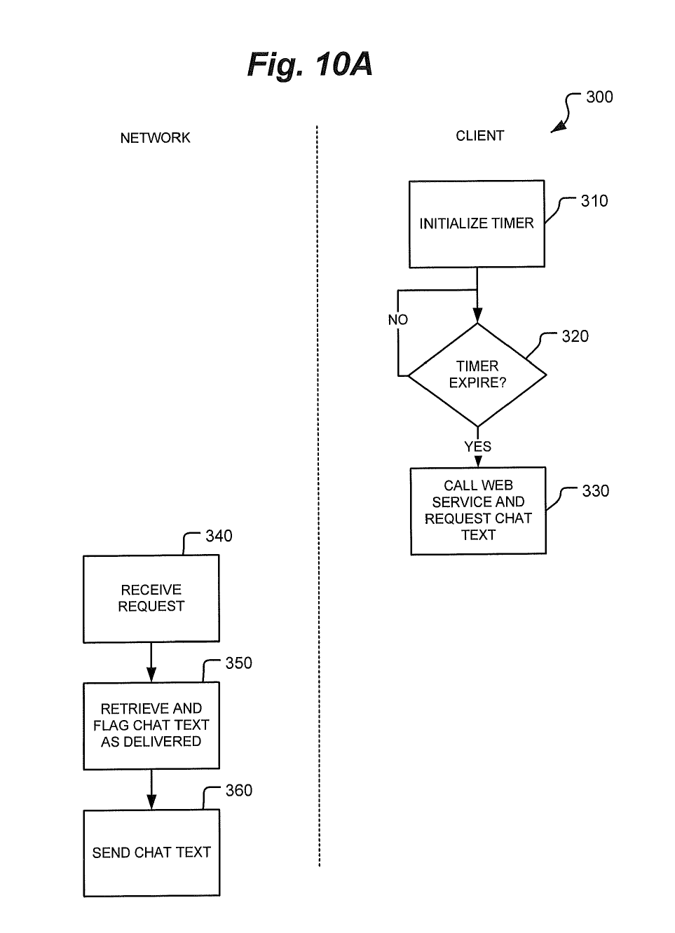

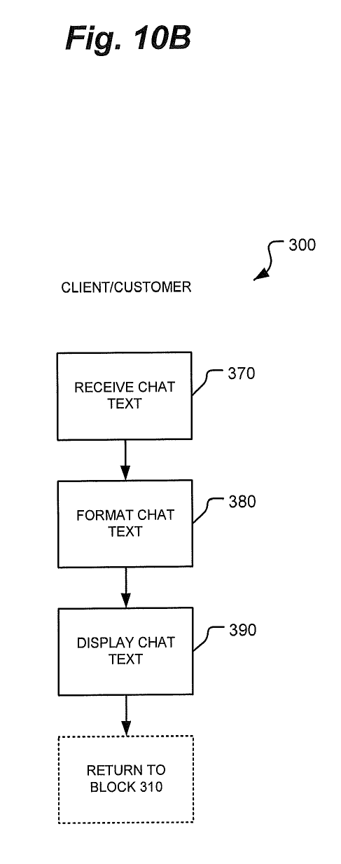

Referring now to FIGS. 10A and 10B, there is shown a block diagrammatic representation of a process 300 according to an embodiment of the present invention. In certain embodiments of the present invention, process 300 is well suited for use as at least part of chat application 94 commenced at blocks 92, 93 (FIG. 7),

Process 300 begins with a timer being initialized at block 310, such as by the chat application 94 (FIG. 7). When the timer is determined to have expired at block 320, a web service or other process may be called to check for undelivered chat information, such as that information stored in a SQL database, e.g., the database discussed with reference to FIG. 9. Again, the called service or process may correspond to the chat application 94 (FIG. 7). Also again, the service or process may call one or more chat application 94 related procedures, for example. The request sent at block 330 is received by or on behalf of the SQL database at block 340. The received request is processed by or on behalf of the SQL database, and undelivered messages for the requesting user are retrieved at block 350. At block 360, the retrieved text is sent to the requesting user (e.g., the user sending the request at block 330).

Referring now to FIG. 10B, the content sent at block 360 is received at block 370 (e.g., the requester or registrant sending the request at block 330). The received text is formatted for display by the electronic document (e.g., webpage or window) or website at block 380 and displayed at block 390. Processing then returns to block 310, such that the timer is again initialized.

In certain embodiments of the present invention, messaging exchange may not be peer-to-peer in nature. Rather, messages sent may be posted to a database, from which it is delivered to the intended recipient. The database stored messages may be pushed to or pulled by the recipient's computing device. Such a database may also advantageously serve as a repository for chat transcripts, for example.

Processing can continue in such a manner to provide bi-directional chat services between registrants and requesters.

In certain embodiments of the present invention, such a database may be used to additionally provide for such a chat session to be effected using bidirectional SMS messaging, for example. For example, analogous code may be used to provide chat messages to and pull chat messages from such a database, and translate them between an HTML compatible format suitable for use with the above-described methodology and text suitable for use with SMS messaging. Such code may receive chat messages from SMS device chat users via SMS messaging and store them in the database, and retrieve messages for SMS device chat users and deliver them via SMS messaging.

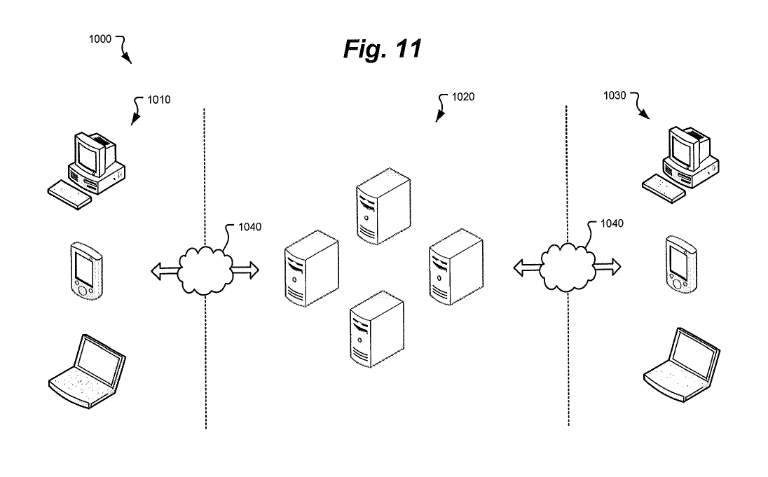

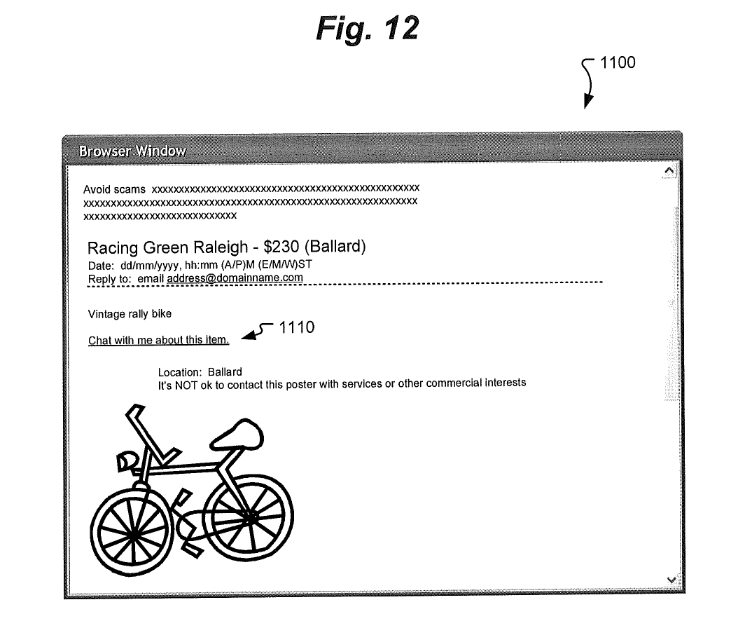

Referring now to FIG. 11, there is shown a configuration of a system 1000 according to an embodiment of the present invention. In certain embodiments of the present invention, system 1000 is well-suited for performing the functionality described herein.

System 1000 generally includes a first class of computing devices 1010, a second class of computing devices 1020 and a third class of computing devices 1030. In certain embodiments of the present invention, the groups need not be mutually exclusive. For example, one or more certain computing devices may be members of more that one of classes 1010, 1020 and/or 1030. Generally, each of the computing devices of classes 1010, 1020 and 1030 are communicatively interconnected with one another via at least one network, such as the Internet and wireline and wireless communications networks. In the illustrated embodiment of FIG. 11, the computing devices of class 1010 are interconnected with the computing devices of class 1020 and the computing devices of class 1030 via network connections 1040. In certain embodiments of the present invention, one or more of the computing device interconnections, such as connections 1040 by way of non-limiting example, may take the form of Internet or other data network connections.

In certain embodiments of the present invention, class 1010 computing devices may generally take the form of end-user computing devices, such as personal computers, terminals, personal digital assistants and/or cellular or telephones or smart phones, for example. In certain embodiments of the present invention, class 1010 computing devices may correspond to customer computing devices, such as those discussed in above, for example.

In certain embodiments of the present invention, class 1020 computing devices may generally take the form of servers, for example. In certain embodiments of the present invention, class 1020 computing devices may correspond to network or system servers, such as those discussed above, for example.

In certain embodiments of the present invention, class 1030 computing devices may generally take the form of end-user computing devices, such as personal computers, terminals, personal digital assistants and/or cellular telephones or smart phones, for example. In certain embodiments of the present invention, class 1030 computing devices may correspond to client computing devices, such as those discussed above, for example.

By way of further, non-limiting example, in certain embodiments of the present invention, a specially configured URL may be placed in an online advertisement. A viewer that clicks on this link will initiate a chat session with the author of the advertisement, for example.

Embodiments of the present invention may utilize client script, client-side script, or client-side code. A generic text website might not have any client script. For an interactive website however, computer code is generally needed. When a website allows dragging items for example, computer code is typically needed to implement the dragging activity. This code is called client-side script or client-side code. This code gets downloaded with the web page and is run by the client computer. The code is downloaded from a server, but the code is not run on the server; the code runs on the client computer (the user's computer). The language of this client-side script is typically JavaScript, although a host of other languages exist for this purpose.

Embodiments of the present invention may relate to cross-domain communication or cross-domain scripting. Cross-domain communication is the practice of communicating with two web servers at the same time. In general this is regarded as a security problem and is disallowed. For example, if a user is using a website known as www.Mybank.com, a malicious cross-domain script might communicate banking credentials to a different web server. Two domains (Mybank.com and RussianGangsters.com let's say) are involved in this transaction, hence the term cross-domain. In certain embodiments of the present invention, a technique that allows for safe, legal, and industry-acceptable cross-domain communication may be provided.

Certain embodiments of the present invention may use one or more http handlers. An http handler is a file that is perceived as say, an HTML file or a JPEG file by a client browser. On the server it is not an HTML file or a JPEG file, it is a code page that gets executed when the request is made. So for instance if a client browser clicked on an http handler configured as a JPEG file, the client browser is expecting to get a JPEG file as a result of this request. On the server this handler might create a JPEG file on the fly, perhaps a little image with the current date, time and temperature. The server sets the response type to JPEG, and then sends the data to the client browser. From the client browser's perspective all that has happened is that it requested and received a JPEG file. It was an http request that was “handled” by the server.

Certain embodiments of the present invention may use JavaScript injection. In a simple form, client-side script gets downloaded along with the web page. When code is downloaded later (after the page was downloaded) it is called a JavaScript injection. Additional client-script has been “injected” into the page.

Certain embodiments of the present invention may use frames and/or iframes. Multiple websites can be displayed in the context of a single web page by use of frames or iframes. For example if a user visits a news or entertainment website she might see a column on the right hand side of the page displaying ads hosted by Google. Such ads are typically contained within an iframe. Frames and iframes from different domains cannot communicate with each other. And so, in this scenario, the column of advertisements is completely separate from the other content on the page and behaves as if it were contained within a completely separate browser window.

Certain embodiments of the present invention may provide or use two categories of functionality: Functionality that takes place on a client computer (a user's computer), and functionality that takes place on a web server. The client functionality may, in certain embodiments, consist in large scope as clicking a link that has been placed in an online advertisement, and entering content, such as text, (chatting) in the interface that appears (the interface that appears as a result of clicking on the link). The server functionality may, in certain embodiments, consist in large scope of (a) a simple website or website functionality to monitor chat requests, and (b) hosting a client script, and receiving and conveying text that is being exchanged between client computers or computing devices.

In certain embodiments of the present invention, an advertiser may place an advertisement in an online marketing vehicle such as Craigslist. Referring now to FIG. 12, there is shown a view of such an advertisement 1100 for a “racing green Raleigh” bicycle. Advertisement contains a link 1110 with language to the effect of “click here to chat about this advertisement” or “click here to chat with the advertiser that placed this ad.”

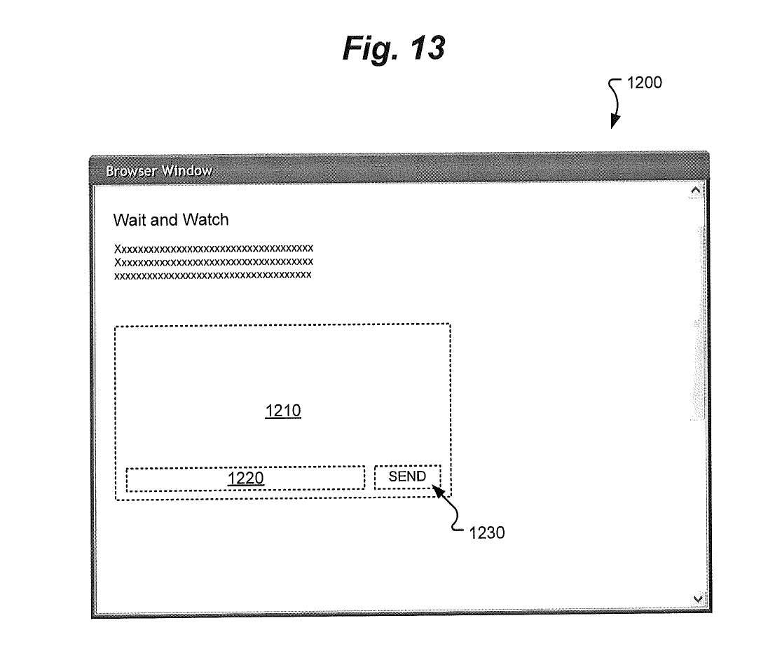

In certain embodiments of the present invention, the advertiser may monitor a website or website functionality that displays incoming chat messages. Referring now also to FIG. 13, there is shown a view of such a website 1200. In the illustrated embodiment of FIG. 13, website 1200 includes a content box 1210, which may display content which has been exchanged, such as text. In the illustrated embodiment of FIG. 13, website 1200 includes a content entry box 1220, which may be used by the advertiser to enter content to exchange, such as text, which will then appear in box 1210 when a “send” button 1230 is activated. In certain embodiments of the present invention, a more elaborate notification system may be used so the advertiser need not sit and wait for messages to appear.

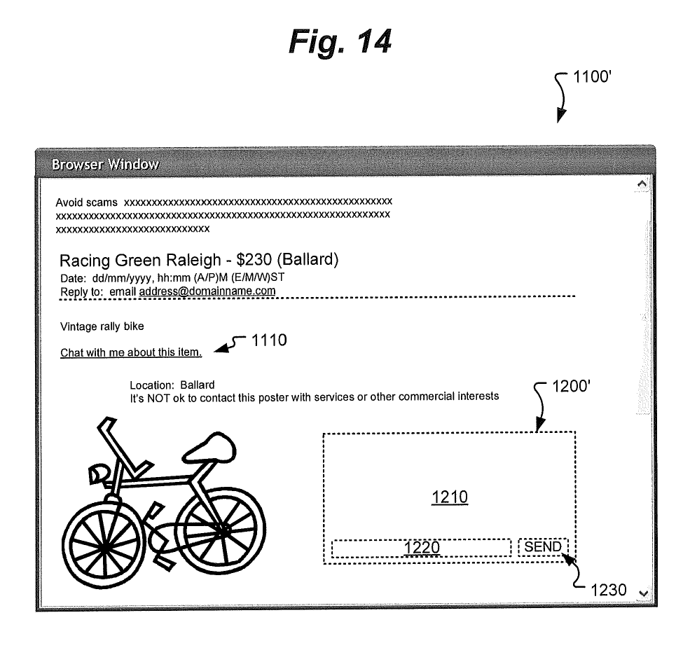

In the illustrated cases of FIGS. 12, 13, a consumer may navigate to advertisement 1100 and click or otherwise activate link 1110. According to certain embodiments of the present invention, various things may happen at this point that the consumer may not necessarily notice. In certain embodiments the server may know or determine what web page the click (e.g., activation of link 1100) came from (the “referrer”) using conventional techniques. The server may then access or otherwise “grab” a copy of this page. The server may add client script to this page that will create a chat window. The server may then send this page 1100′ back to the consumer. When the page loads a chat window 1200′ may appear, such as is shown in FIG. 14. The consumer may not even be aware that the page has been reloaded since it is the same page essentially and has not otherwise seemed to change in appearance.

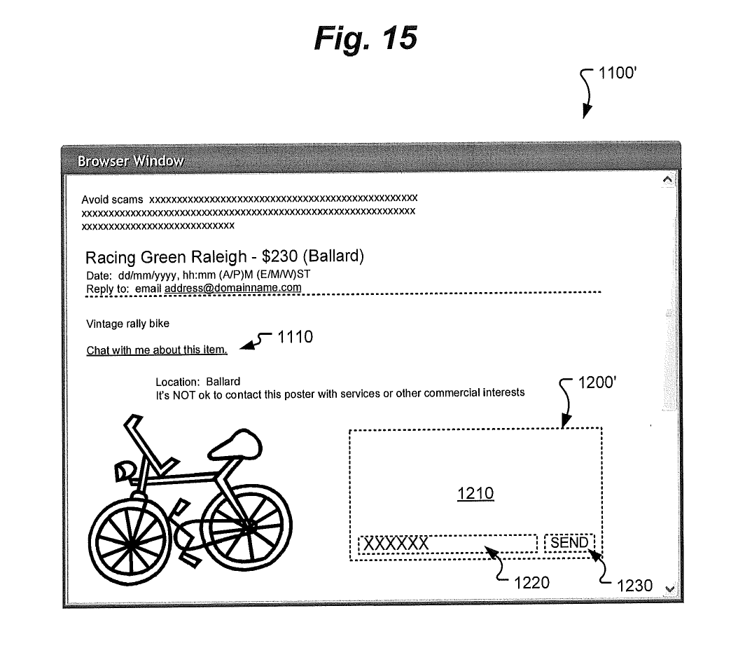

The consumer may then begin typing into the chat window (e.g., using 1220/1230) to ask a question about or otherwise discuss the advertised service or product. This text may then appear substantially instantly to the advertiser who is watching and waiting for such messages. FIGS. 15 and 1 illustrate such a functionality. The advertiser and consumer may then commence typing messages to each other through this interface, an activity commonly known as online chat.

It should be appreciated that in the illustrated embodiments of FIGS. 12-16, the chat window resides within and together with the underlying page and may feature a low degree of latency, such as less than 5 seconds for exchanges. It may thus be possible for the chat window to convey to another user the contents of the underlying page. For example, a seller that has advertisements in multiple venues could—with proper instrumentation—view the page on which the consumer is chatting upon. And so, if a consumer had clicked on an advertisement in Craigslist, the seller could see the particular Craigslist page as he or she chatted with the consumer.

Certain embodiments of the present invention may be well suited to be used in conjunction with a third party website. Online advertising generally does not permit one to add client-side script code to an advertisement. If this were the case, one could easily implement chat or any other functionality from within the advertisement. One may typically be allowed, however, to place a simple URL in an online ad which refers the consumer or user to more information (see, e.g., FIGS. 2B and 12). Embodiments of the present invention may thus allow a user to add functionality to a third party website by providing a click-able, simple URL that contains no script code itself, for example.

Another, non-limiting exemplary embodiment of the present invention that is simplified so as to not include code that would uniquely identify chat sessions, for example will not be discussed. In a commercial implementation of this invention, one may wish to keep chat sessions of one user separate from another, for example. This may be accomplished by a number of standard methods, including, for example: cookies, specially formatted or encoded URLs representing a user ID, session variables, or sundry other methods for uniquely identifying users and session state, for example.

Certain embodiments of the present invention may be implemented with two physical machines or computing devices, various services and delivery systems on those machines, as well as additional components. In this specific example implementation the following distinct machines, systems, and components are used.

In the discussed exemplary embodiment a client computer and server computer are used. Systems and services residing on these machines are as follows.

Client Computer System: Browsing Software—In certain embodiments, the Client Computer may take the form of any computing device connected to the Internet and capable of running modern Internet browsing software. In certain embodiments of the present invention, the only client computer software needed would be the Internet browsing software such as Mozilla, Internet Explorer, Opera, Google Chrome, or Apple Safari to mention a few.

Script Server Computer System: Web Server and Database Server—In certain embodiments, the Script Server Computer may take the form of any computing device capable of running modern web server software. In this example implementation, a Microsoft Windows Server 2003 with its native capability of interpreting .NET Active Server Pages (ASP .Net) is proposed. The Web Server used may be IIS. The Database Server may be any SQL-capable server. In the discussed implementation, a Microsoft SQL 2000 Database Server is proposed. However, in other embodiments each individual function may be handled by a different server or a group of servers for example. In such a deployment there may be separate and multiple servers hosting the script, separate and multiple servers hosting the database, and so forth. In this example these services have been combined on a single physical machine.

In certain embodiments of the present invention, no additional components need to be installed on the Client Computer.

In certain embodiments of the present invention the following additional components residing on the script server computer may be provided on the server.

In certain embodiments a website where an ostensible advertiser can watch and wait for users to initiate chat; and the client script and supporting software for the chat window may be provided. In certain embodiments of the present invention, the “watching and waiting” website may be provided using a simple web page that references the client script (both parties in the chat use the same script to create the chat interface).

In certain embodiments of the present invention, the following components for the client script and support software may be provided.
urlChatPanel.js—the client script that creates the chat window
Handler.ashx—the advertisement contains a link with language to the effect of “click here to talk to the advertiser;” this is the target of that link
getChat.ashx—the code that retrieves text entered by the other user
setChat.ashx—the code that sends text entered by a user

In this example implementation, a database for recording and retrieving chat text may be used. A SQL Server Enterprise Manager may be used to create a database named “urlChat.” Under Users, access to the database may be to these default users: BUILTIN\Administrators; NT AUTHORITY\NETWORK SERVICE; YOURSERVERNAME\IUSR_STD-B.

A table may be created in this database called “ChatRecords.” The fields added to the table may take the form of:
Session Number, nvarchar, 50
Retrieved, bit, 1, default 0
ChatText, nvarchar, 255
RecordNumber, bigint, 8, Identity:Yes, Identity See:1, Identity Increment, 1
UpdatedBy, nvarchar, 50

Specific permissions may be provided for SQL tables, such that SELECT, INSERT, UPDATE, and DELETE permission may be given to the three built in users mentioned previously.

c:\Inetpub\wwwroot may be used as the default web server website location in Windows Server 2003 Internet Information Services Manager. Under this folder, a folder for the website called “urlChat” may be created. The server components briefly described previously may be placed in this folder: website.htm, getChat.ashx, setChat.ashx, Handler.ashx, and urlChatPanel.js.

The website folder may be configured as an application, to facilitate the .ashx files functioning properly. This may be accomplished in IIS by drilling down from the Web Sites folder to the folder containing one's website, right-clicking the website's folder, and clicking the Create button. This will cause IIS to consider the folder an application and IIS will signify this by replacing the folder icon with a gear icon.

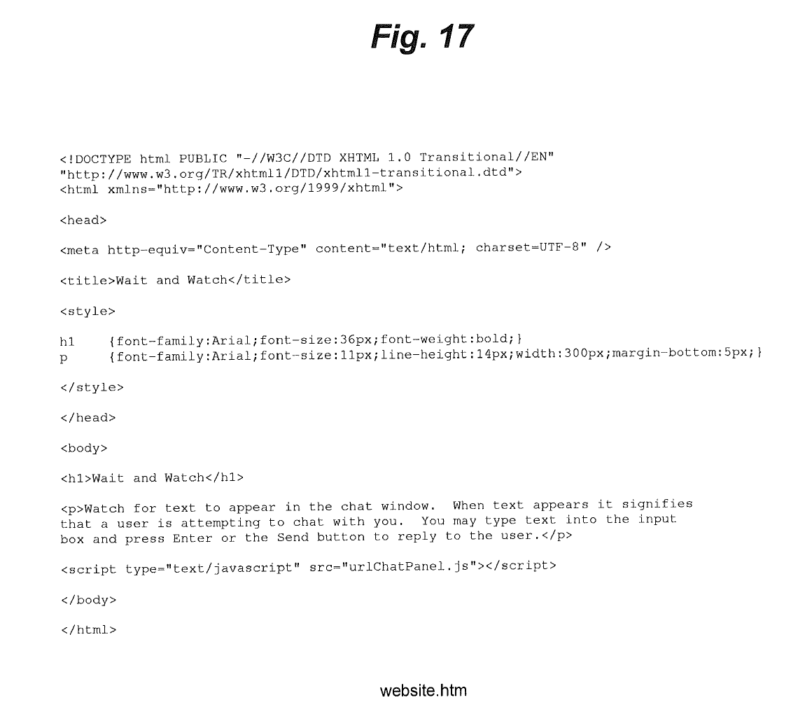

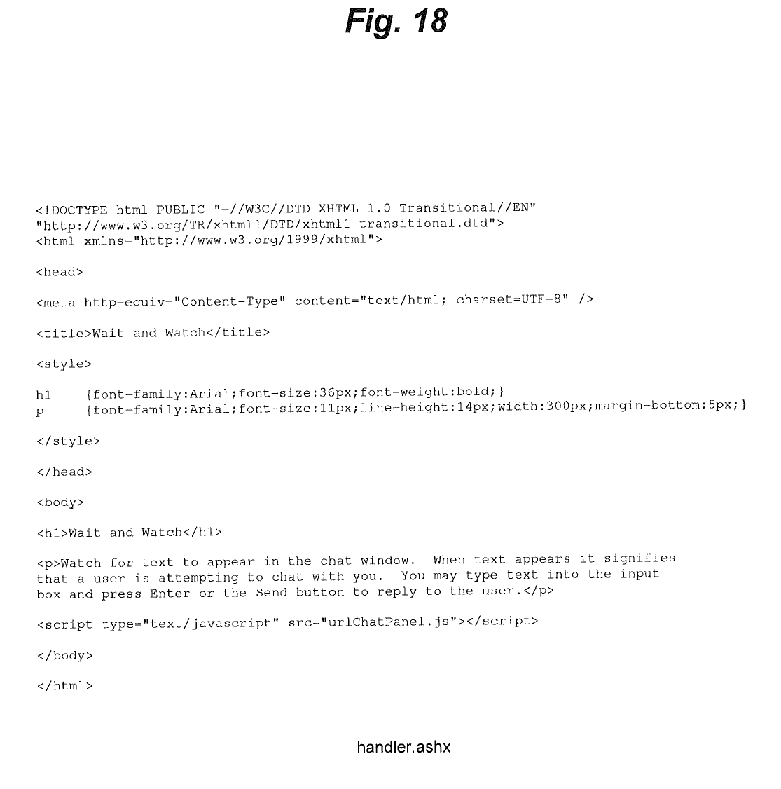

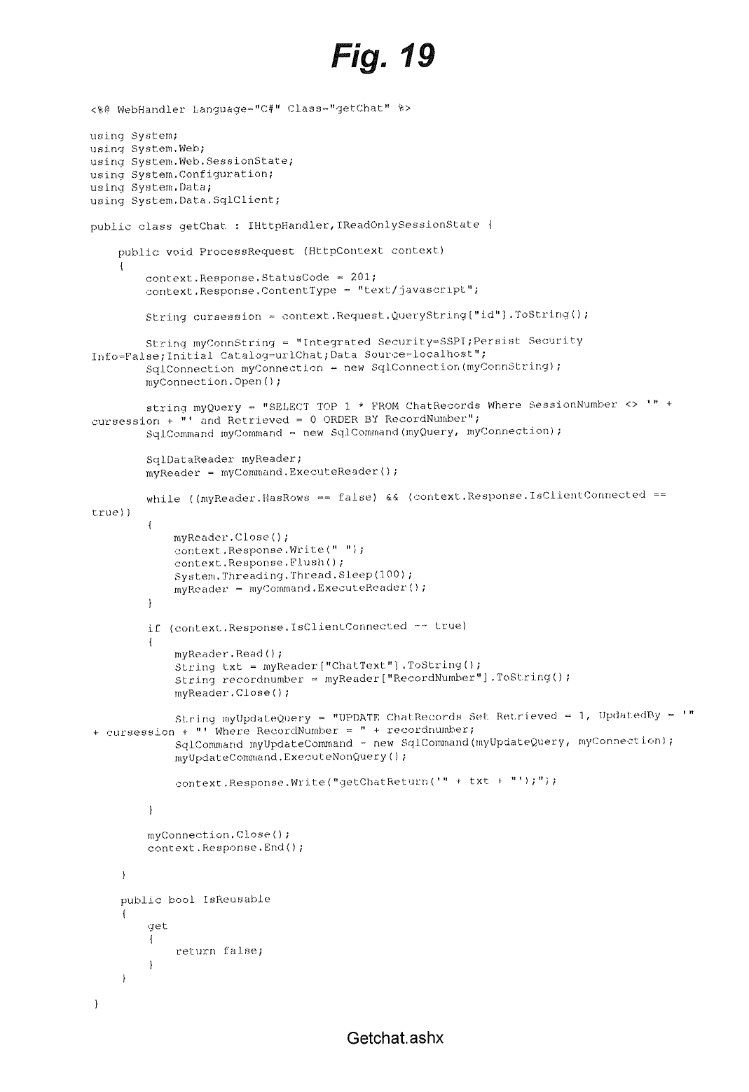

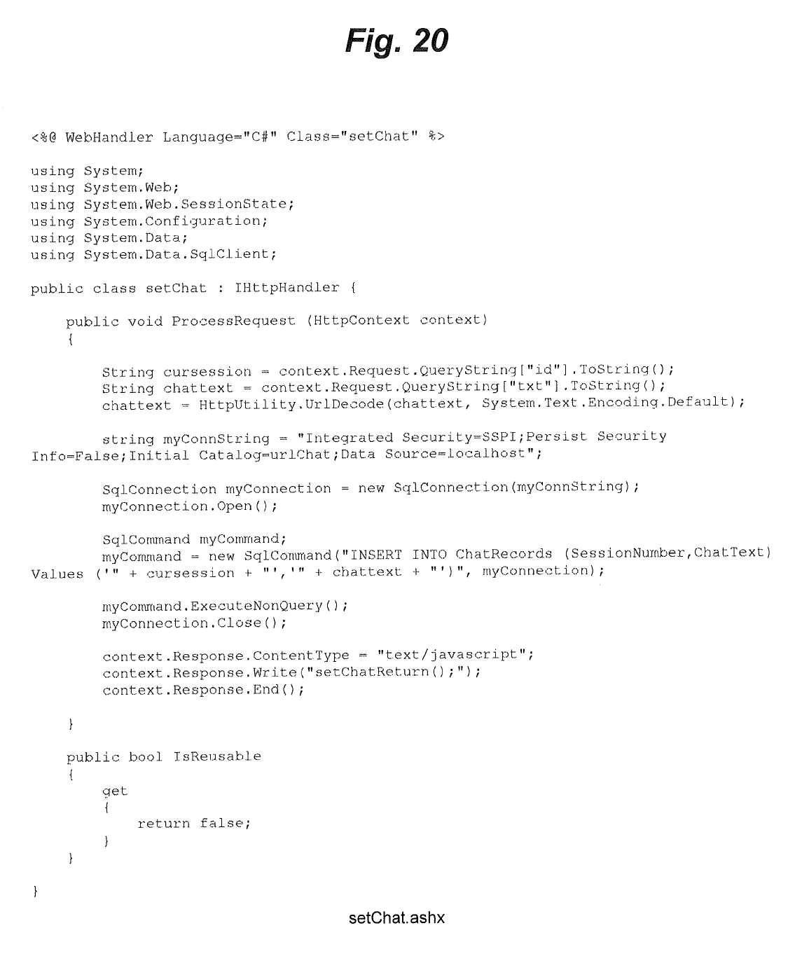

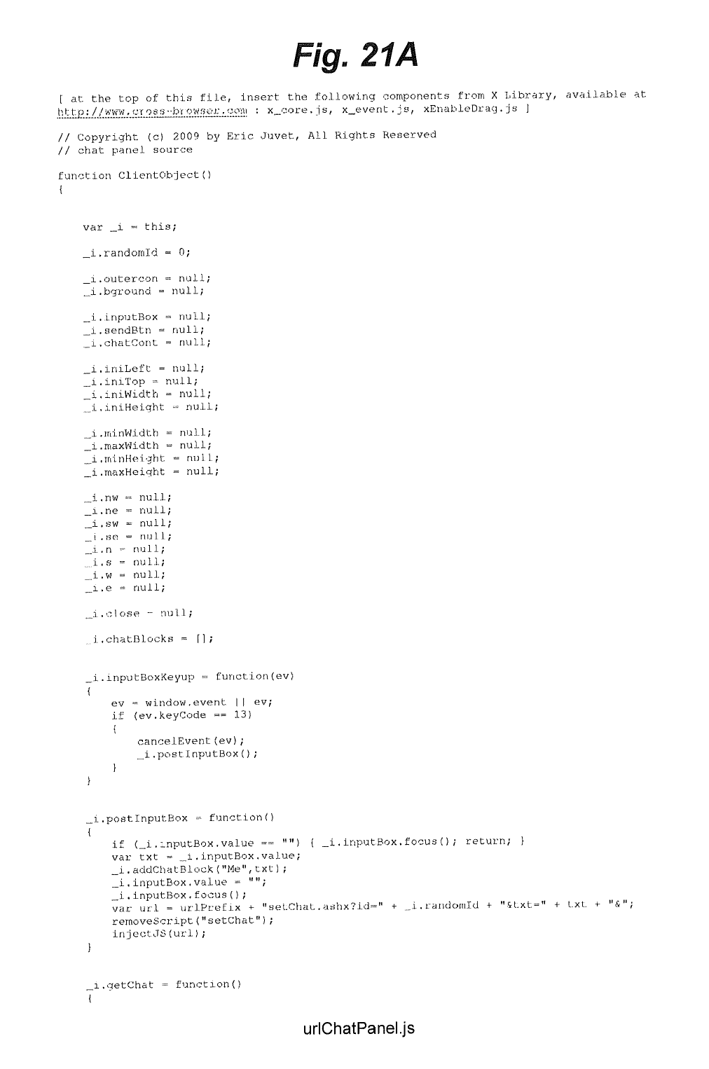

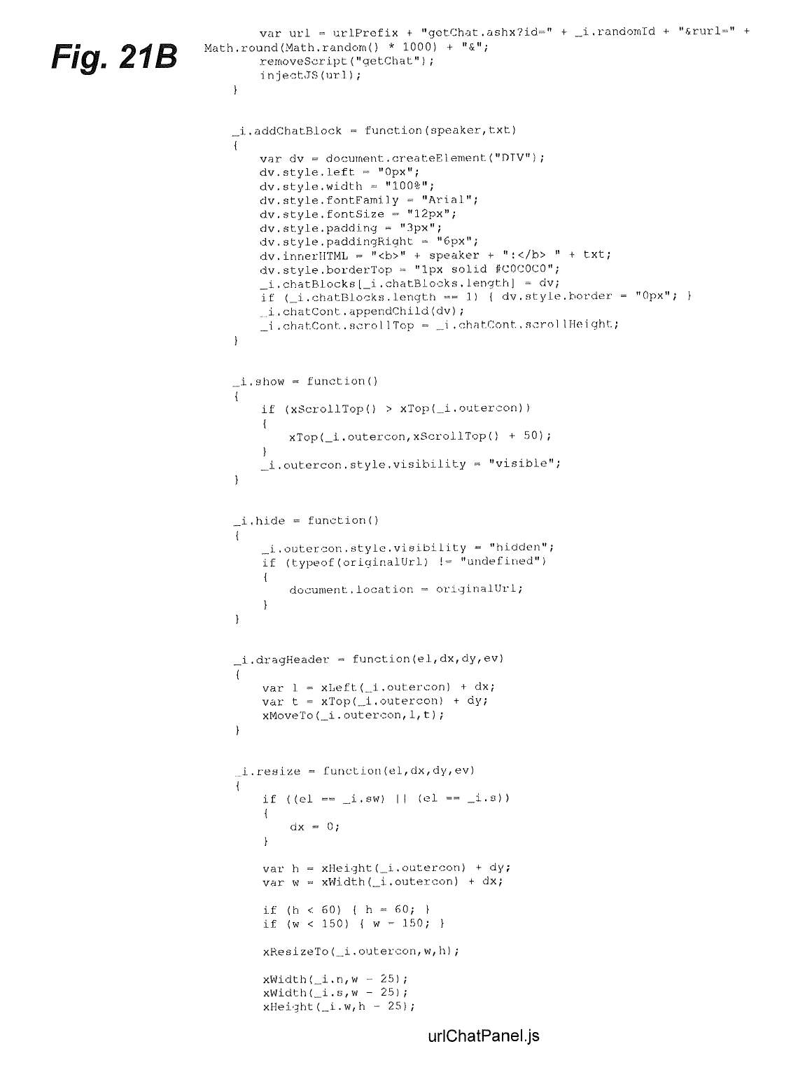

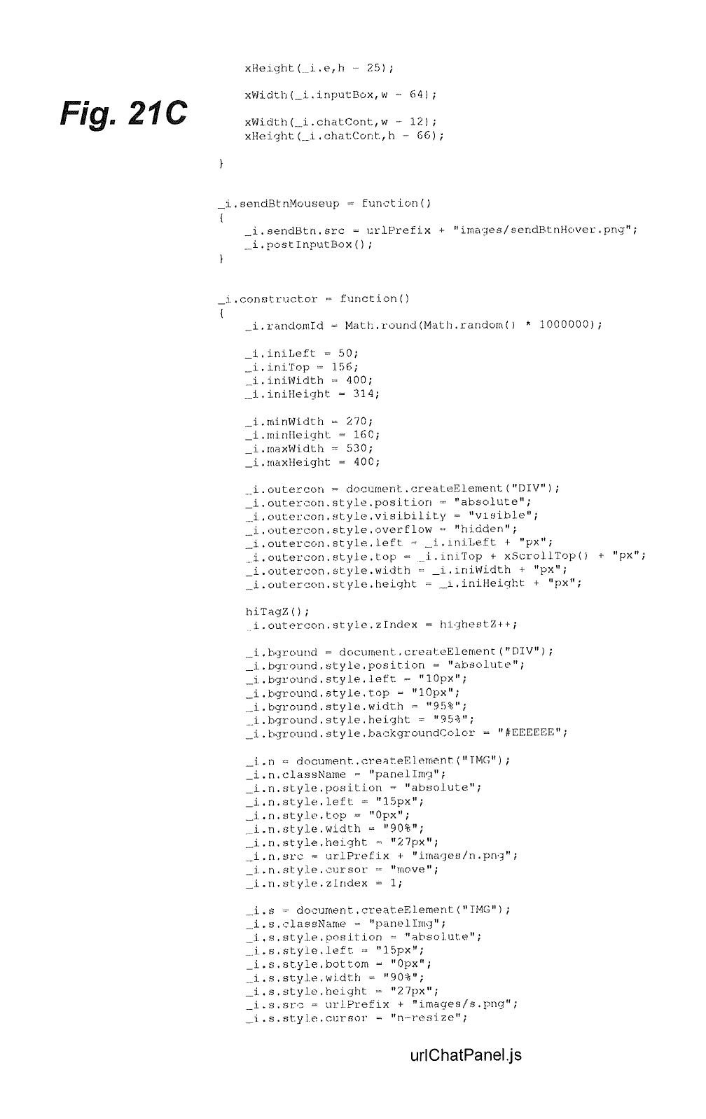

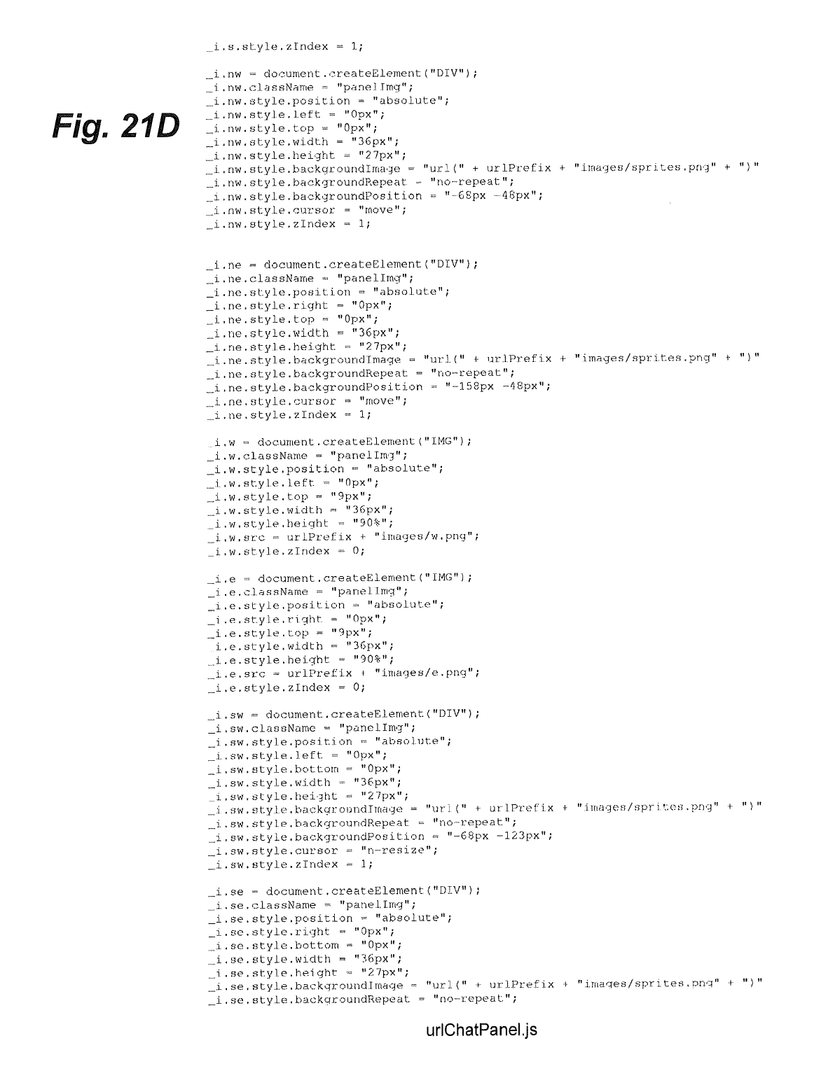

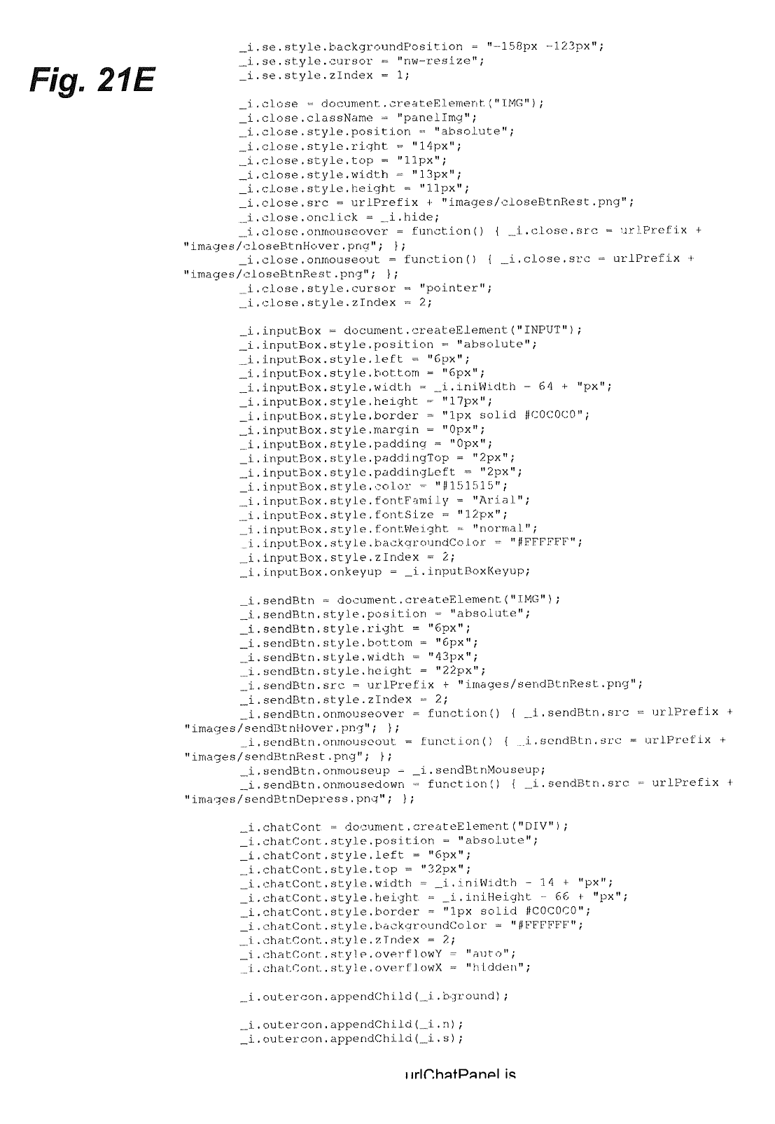

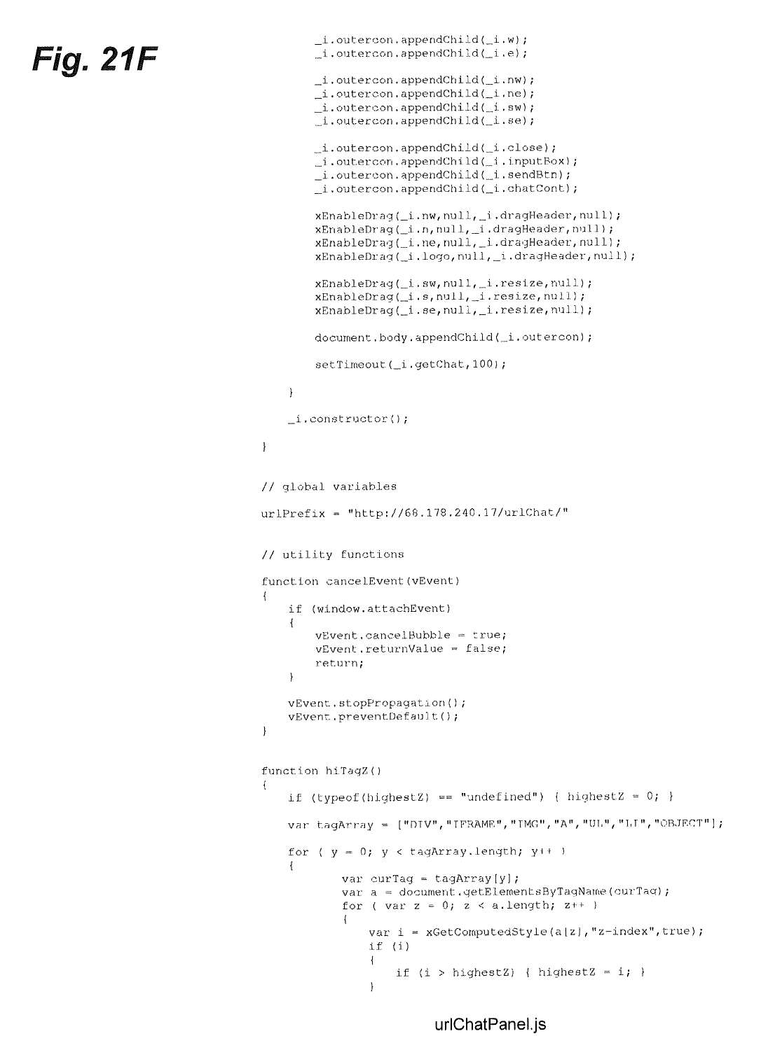

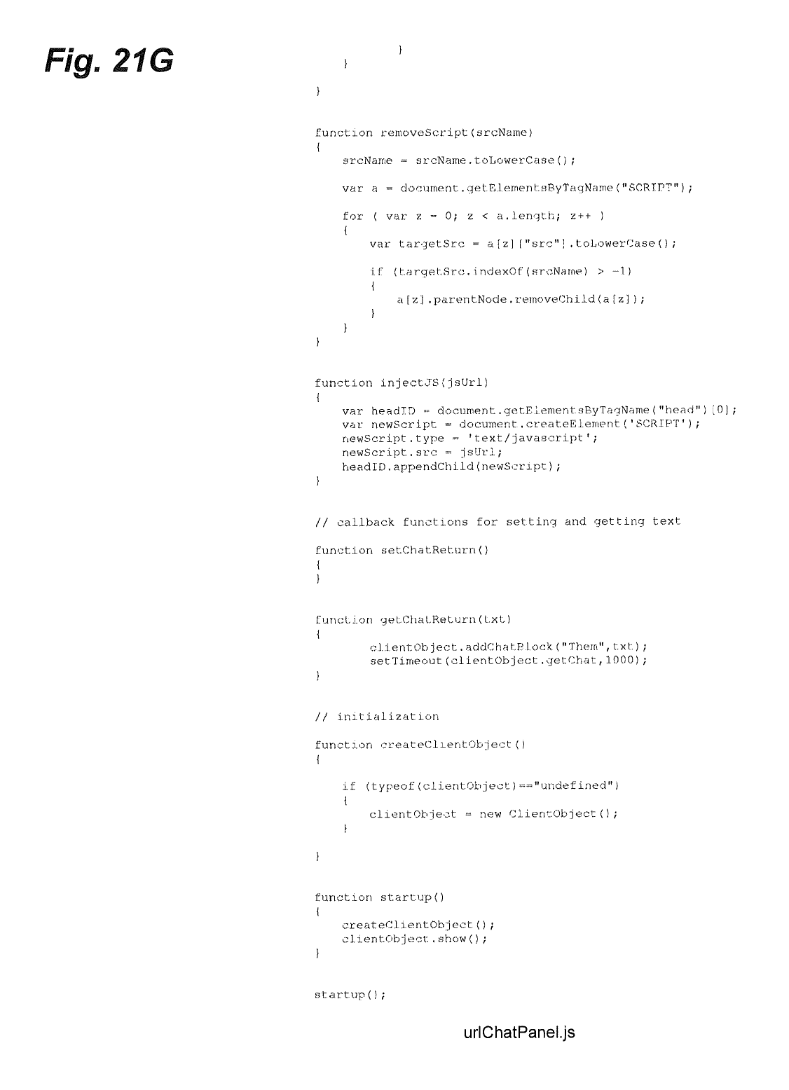

With such a setup implementations that provide the technical functions described below may proceed. Non-limiting, exemplary code listings for the components used in this example implementation are shown in FIGS. 17-21G. However, the discussed functions described below may be provided for in any web server language and environment combination.

website.htm may be the component that takes the form of the “wait and watch” web page shown in Table 4. Functionally this example implements a headline, simple instructions, and a reference to the urlChatPanel.js script. Upon loading the urlChatPanel.js script creates a chat window interface that will display incoming text from users.

TABLE 4
<!DOCTYPE html PUBLIC “-//W3C//DTD XHTML 1.0
Transitional//EN”
“http://www.w3.org/TR/xhtmll/DTD/xhtmll-transitional.dtd”>
<html xmlns~“http://www.w3.org/1999/xhtml”>
<head>
<meta http-equiv=“Content-Type” content=“text/html; charset=UTF-8” />
<title>Wait and Watch</title>
<style>
<h1> {font-family:Arial;font-size:36px;font-weight:bold;}
p {font-family:Arial;font-size:llpx;line-height:14px;width:300px;margin-
bottom: 5px;}
</style>
</head>
<body>
<h1>Wait and Watch</h1>
<p>Watch for text to appear in the chat window. When text appears it
signifies that a user is attempting to chat with you. You may type text into
the input box and press Enter or the Send button to reply to the user.</p>
<script type=“text/javascript” src=“urlChatPanel.js”></script>
</body>
</html>

urlChatPanel.js may be the script is stored on the server, downloaded, and run on the client browser. It may be implement ed in the JavaScript language. It may construct the chat window interface that the user and the advertiser see and interact with. The overall organizational structure of this code from top to bottom may be:

X Library
ClientObject
global variable(s)
utility functions
callback functions for setting and getting text
initialization

xLibrary is a publicly available JavaScript library called the X Library which is distributed under terms of the LGPL license and is available at http://www.cross-browser.com. These components from X Library may be used, and the code directly copied into urlChatPanel.js: x_core.js, x_event.js, and xEnableDrag.js. Different browsers implement events such as click and mousemove in different fashions. The X Library components may be used to provide a single normalized interface for browser events. It may also be used to provides a dragging capability that allows a user to move and resize the chat window, and various utilities such as string formatting as well.

ClientObject may define an object that creates a graphical chat window in the user browser, and controls the setting, getting, and display of chat text.

A global variables section contains global variables named “urlPrefix” whose scope is available to the entire script. Relative URLs cannot be used in the exemplary urlChatPanel script. Code and functionality is being superimposed onto a third-party website and the script may be running in a context other than the system providers. Therefore images and other resources used by urlChatPanel should be preceded with a absolute location.

utility functions used by urlChatPanel.js are:
cancelEvent, which is used to cancel an event such as a click so that the click for example, does not trigger other events.
hiTagZ, which is used to determine the highest Z-order object on the webpage it is called from. When the chat window is created, it may be desired to be on top of the rest of the page. Know the elevation of the currently topmost element facilitates this.
removeScript may be used in conjunction with setting and getting text. The same JavaScript file may be continuously (or substantially continuously) injected over and over. Each time this file is injected, the current version of it may first be deleted.
injectJS may be used to inject JavaScript containing the current chat text. The method used communicate with the server may depend on this. Communication may consist of the server creating a JavaScript file containing the current chat text, and the client computer injecting this JavaScript to retrieve that text.

callback functions used by urlChatPanel are setChatReturn and getChatReturn. In this example setChatReturn contains no code. It is called to signify that the setting of text (that is, sending the user input to the server) has been accomplished. Additional code may be placed in this function to trigger some additional functionality at the conclusion of setting text. getChatReturn is the function called at the conclusion of retrieving chat text from the server. This function passes the chat text into the ClientObject for display in the chat window, then calls the getChat method of the ClientObject to retrieve the next chunk of text entered by the other user. Once getChat has been called, the request hangs indefinitely until the server has new chat text to send back.

An initialization section of urlChatPanel creates the chat window if necessary, then displays it. The initialization section may be called each time urlChatPanel is loaded. It may check to see if the ClientObject already exists: if the user has closed the ClientObject it still exists, it is just not visible. If the ClientObject does not exist, the constructor will be called to create it. Once the existence of the ClientObject is ensured, initialization sets the ClientObject to visible (the ClientObject may by invisible because the user has previously dismissed the chat window).

Handler.ashx is the component that is the target of the advertiser's URL. So the advertisement may include a URL such as that shown in Table 5.

TABLE 5

<a href=“http://68.178.240.17/urlChat/handler.ashx”>
Chat with me about this item
</a>

The visible appearance of this link in an advertisement would be “Chat with me about this item.” The mimetype of this file is text/html and so the client browser perceives this file as an HTML file. On the server this may in fact not be an HTML file, but rather a code page that accomplishes a number of things and is known as an HTTP handler. Once the user has clicked on the URL, the browser may make a routine request to the server for the file Handler.ashx. In series these actions may take place on the server, as the server executes the code page Handler.ashx:
(1) the server analyzes the request and gets the referrer property; if for example if the user were on Craigslist his current browser location might be http://seattle.craigslist.org/see/bik/129483274.html, when he clicks on the “Chat with me about this item” link the referrer would be exactly the same location http://seattle.craigslist.org/see/bik/129483274.html.
(2) the server makes an http request of its own, it requests the page http://seattle.craigslist.org/see/bik/129483274.html and stores the HTML that is returned temporarily in a string; this HTML may typically be exactly the same as what the user is currently seeing on his browser.
(3) the server appends to this HTML the script urlChatPanel.js which is the code that creates the chat window.
(4) the server appends additional script which contains a variable with the referrer URL.
(5) the server sets the mimetype of the response to text/html then writes the HTML string out, effectively sending the HTML string back to the client browser.

The client browser receives the HTML string and displays it, typically displaying exactly the same web page that currently is being viewed. At the end of the HTML string the script urlChatPanel has been appended to the HTML string so that once the HTML page has rendered, the urlChatPanel script is executed. The urlChatPanel script runs its initialization code, creates the chat window interface, and makes itself visible. And so the chat window now appears on top of the web page that the user was browsing.

getChat.ashx is an http handler that returns text entered by the other user. It is used by the script urlChatPanel.js. It is called from within the ClientObject, the primary object created in the initialization of the urlChatPanel script. Immediately after urlChatPanel has constructed the visible chat window interface, it makes a call to getChat.ashx. It does this by constructing a URL: var url=urlPrefix+“getChat.ashx?id=”+_i.randomId+“&rurl=”+Math.round(Math.random( )*1000)+“&”; injectJS(url); and then requesting this file as a JavaScript injection using the utility function injectJS. On loading urlChatPanel has assigned itself a random id and stored it in the variable ClientObject.randomId. This id number is analogous to a session number, and is passed with every getChat request in order to identify the requestor.

The other parameter on the url is a random number that is generated on every request. And so the first parameter is the same throughout the session, and the second parameter changes each time injection for getChat.ashx is made. The second parameter serves no function except to cause the URL to be different on each call. If the URL remains the same through each call, the utilized browser may ignore the request.

The type of request represented here (JavaScript injection) is asynchronous, so leaving a request pending does not impact the performance of the browser. If there is chat text to be retrieved, getChat.ashx will return immediately and call the getChatReturn function of urlChatPanel to signify its completion.

However, if there is no text to be retrieved the request remains pending. It can remain pending in this state for any duration of minutes, hours, or perhaps even days. And so only a single request for each piece of chat text returned may be made. In a less efficient system, the client might poll the server every few seconds to see if text were available for retrieval. Such polling places a burden on the web server though. In this system there is no burden of inefficiency, it is 100% efficient since only one request is made for each piece of text retrieved. In a polling-based system dozens or possibly hundreds of requests might be made to retrieve a single chat text item.

getChat.ashx is an http handler which the client browser perceives as a JavaScript file but which in fact may be a code page on the server. Once the request for the file getChat.ashx is made, the getChat.ashx http handler conducts a series of actions on the server:
(1) the handler sets the response type to 201, sets the mime type of the response to be text/javascript, and retrieves the session number of the current request as shown in Table 6.

TABLE 6

context.Response.StatusCode = 201;
context.Response.ContentType = “text/javascript”;
String cursession = context.Request.QueryString[“id”].ToString( );

(2) the handler constructs an SQL query and requests chat records be returned, as shown in Table 7.

TABLE 7
string myQuery = “SELECT TOP 1 * FROM ChatRecords Where
SessionNumber <> ‘ “ + cursession + ” ’ and Retrieved = 0 ORDER BY
RecordNumber”;

The meta meaning of the SQL query is: “get the oldest (first) single record from the ChatRecords table—get the oldest because we are going to make subsequent requests and we want to get them in chronological order”, “get records that do not have the same session number as me—we want the other party's text, not our own”, “get records that have not previously been retrieved”.
(3) the handler continues requesting records in a loop (until it finally gets a record). The loop is timed at an arbitrary rate, here it is 10 times per second. During this loop the request from the client is still pending and may remain pending for a long while. At every pass of the loop the server writes a benign character (a space) out to the client and flushes the write so that it actually is sent to the client, as shown in Table 8.

TABLE 8

while ((myReader.HasRows == false) &&
(context.Response.IsClientConnected == true))
{

myReader.Close( ) ;
context.Response.Write(“ ”);
context.Response.Flush( );
System.Threading.Thread.Sleep(100);
myReader = myCommand.ExecuteReader( );

}

The loop fails on either of these possible conditions: a record was returned (HasRows==true) or the client has become disconnected. Disconnection can be detected with provocation from the space character. If the client is disconnected (the browser was closed or browsed away to another URL) the server will close the socket. When a space character is tried to be written to this closed socket, a SocketException will result. The SocketException changes the IsClientConnected property to false.
(4) the handler exits the loop once it receives a record and checks to see if the client is still connected and if so it (a) updates the database to show the record has been retrieved and (b) writes the retrieved chat text out to the response and ends the response which causes the client browser to perceive that the pending request is now complete, as is shown in Table 9.

TABLE 9

context.Response.Write(“getChatReturn(‘ “ + txt + ” ’);”);

The response expected by the client is JavaScript. The way that getChat.ashx writes out the retrieved chat text is a single line of JavaScript containing a call to the function getChatReturn, the retrieved text as the parameter. And so the client receives something like getChatReturn(‘XXXXXX’); or getChatReturn(‘how old is your bike’).

Upon the request returning, the JavaScript is evaluated and calls the getChatReturn function in urlChatPanel, causing the chat text to be posted to the user's interface.

ffitChat.ashx is an http handler that sends chat text to the server to be retrieved by the other chat party. It is used by the script urlChatPanel.js. It is called from within the ClientObject, the primary object as created by the initialization of the urlChatPanel script. When chatting, a user enters text into an input box in the chat window interface. For example, when a user presses the Enter key or clicks the Send button (See, e.g., FIGS. 13, 14), text that is in the input box will be sent to the server and stored in the database. This may be accomplished on the client side by calling the postInputBox method of the ClientObject. Within that method, the text value is retrieved and re-displayed in the upper box of the chat window interface with the addChatBlock, such as that shown in Table 10.

TABLE 10

var txt = _i.inputBox.value;
_i.addChatBlock(“Me”,txt);

A url may then be constructed, such that the newly entered text is passed as a parameter on this url. The previous version of the script may then be removed, and the setChat.ashx script reinjected, as is demonstrated by Table 11, for example.

TABLE 11
var url = urlPrefix + “setChat.ashx?id=” + _i.randomId + “&txt=” + txt +
“&”; remove Script (“setChat”);
InjectJS(url);

The randomId parameter is an id that was given when the ClientObject was created. It may serve an analogous purpose to a session number and identify the chat session. It may be stored as a field in the database.

At this point the request for setChat.ashx has left the client browser and processing begins on the server. The setChat.ashx handler derives the chat session and the chat text from the querystring as described above. It may construct an SQL query in accordance with Table 12.

TABLE 12
myCommand = new SqlCommand(“INSERT INTO ChatRecords
(SessionNumber,ChatText) Values (‘ “ + cursession + ” ’,‘ “ + chattext +
” ’)”, myConnection);

Executing the query stores the chat session and the chat text in the database. The retrieved field may be set to false by default, and the sequential record number automatically assigned when the record is stored.

The handler may then set the mime type to text/javascript, write a call to setChatReturn to the response, and end the response in accordance with Table 13.

TABLE 13

context.Response.ContentType = “text/javascript”;
context.Response.Write(“setChatReturn( );”);
context.Response.End( );

Ending the response signals the client that the request has been satisfied and the JavaScript injection is complete. The small bit of JavaScript that was sent is now interpreted: setChatReturn is called and the server update is now complete. In the discussed, non-limiting example, there is no code contained in setChatReturn, such that it is an empty function. However, any code that was desired to be called following the submittal of the chat text to the server may be executed.

FIGS. 17-21G illustrate a non-limiting example of code consistent with the non-limiting example discussed herein.

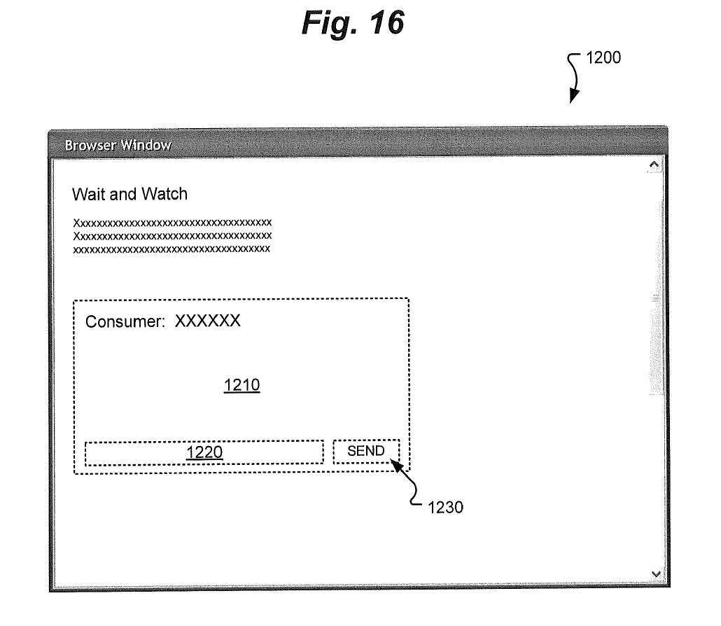

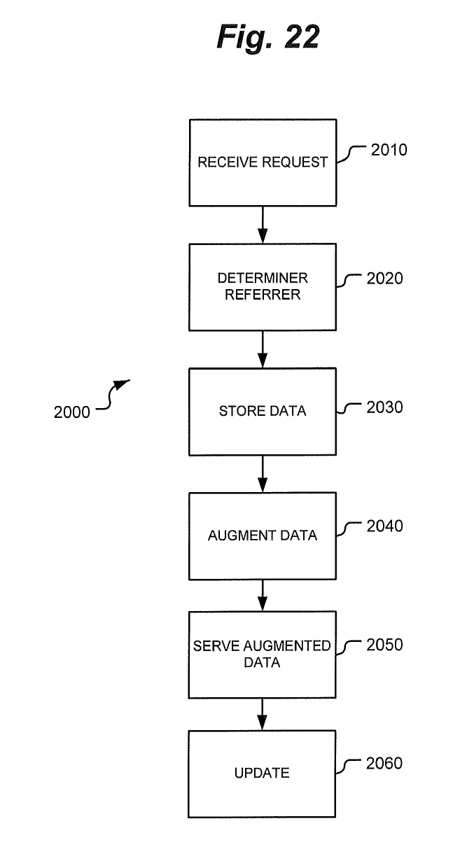

By way of further, non-limiting example, and referring now to FIG. 22, there is shown a block diagrammatic view of a process 2000 according to certain embodiments of the present invention. Process 2000 includes receiving a request corresponding to a user chat request, such as responsively to activation of a chat request link as discussed above (see, e.g., 1110, FIG. 12) at block 2010. At block 2020, a referring electronic document, such as a website or webpage of a website may be identified or determined, as discussed above. At block 2030 information, such data indicative of the webpage and suitable to reproduce the webpage, may be stored, such as by one or more computing devices or servers, as discussed above. At block 2040 at least a portion of the stored data is augmented with a chat application, such as by augmenting stored webpage code with code that implements a chat application, as discussed above. At block 2050, at least a portion of the augmented data is served as is discussed above (see, e.g., FIG. 14). At block 2060, updates to exchange chat information or data, such as text, may be accomplished as discussed above (see, e.g., FIGS. 15, 16).

In certain embodiments of the present invention, once a chat is completed a user's browser may be redirected back to the originally referring webpage that was identified or determined (e.g., at block 2020), such as via updating at block 2060.

It will be apparent to those skilled in the art that modifications and variations may be made in the apparatus and process of the present invention without departing from the spirit or scope of the invention. It is intended that the present invention cover the modification and variations of this invention.

What is claimed is:

1. A computer program product being tangibly embodied in a computer-readable medium and including computer-executable code for enhancing an electronic document including a plurality of advertisements, the computer program product computer-executable code comprising:
code for receiving a request corresponding to an identifier associated with a given advertisement responsively to a user's interaction with the electronic document; and
code for launching a clientless chat application that corresponds to the advertisement responsively to the receiving, regardless of whether the electronic document allows chat-application code to be embedded therein.

2. The computer program product of claim 1, wherein the code for launching comprises code for determining data indicative of a webpage from which the request was generated.

3. The computer program product of claim 2, wherein the code for launching further comprises code for storing data indicative of the webpage from which the request was generated.

4. The computer program product of claim 3, wherein the code for launching further comprises code for augmenting the stored data with chat-application code.

5. The computer program product of claim 4, wherein the code for launching further comprises code for serving the augmented data.

6. The computer program product of claim 5, wherein the augmented data is configured to reproduce the webpage from which the request was generated augmented by a chat-application.

7. The computer program product of claim 6, wherein chat-application code is not embedded in the webpage from which the request was generated.

8. The computer program product of claim 7, wherein chat-application code is not permitted to be embedded in the webpage from which the request was generated.

9. A method for enhancing an electronic document including a plurality of advertisements, comprising:
receiving a request corresponding to an identifier associated with a given advertisement responsively to a user's interaction with the electronic document by at least one computing device; and
launching a clientless chat application that corresponds to the advertisement responsively to the receiving, regardless of whether the electronic document allows chat-application code to be embedded therein.

10. The method of claim 9, wherein the launching comprises determining data indicative of a webpage from which the request was generated.

11. The method of claim 10, wherein the launching further comprises storing data indicative of the webpage from which the request was generated.

12. The method of claim 11, wherein the launching further comprises augmenting the stored data with chat-application code.

13. The method of claim 12, wherein the launching further comprises serving the augmented data.

14. The method of claim 13, wherein the augmented data is configured to reproduce the webpage from which the request was generated augmented by a chat-application.

15. The method of claim 14, wherein chat-application code is not embedded in the webpage from which the request was generated.

16. The method of claim 15, wherein chat-application code is not permitted to be embedded in the webpage from which the request was generated.

17. A method for enhancing an electronic document including at least one content item, comprising:
receiving by at least one computing device a request corresponding to an identifier associated with the content item responsively to a user's interaction with the electronic document; and
sending by the at least one computing device data configured to present an augmentation of the electronic document that includes a clientless chat application which corresponds to the content item responsively to the receiving, regardless of whether the electronic document allows chat-application code to be embedded therein.

18. The method of claim 17, further comprising determining data indicative of a webpage from which the request was generated.

19. The method of claim 18, further comprising storing data indicative of the webpage from which the request was generated.

20. The method of claim 19, further comprising augmenting the stored data with chat-application code.

21. The method of claim 21, wherein chat-application code is not embedded in the webpage from which the request was generated.

22. The method of claim 21, wherein chat-application code is not permitted to be embedded in the webpage from which the request was generated.

23. A computer program product being tangibly embodied in a computer-readable medium and including computer-executable code for enhancing an electronic document including at least one content item, the computer program product computer-executable code comprising:
code for receiving a request corresponding to an identifier associated with the content item responsively to a user's interaction with the electronic document; and
code for sending data configured to present an augmentation of the electronic document that includes a clientless chat application which corresponds to the content item responsively to the receiving, regardless of whether the electronic document allows chat-application code to be embedded therein.

24. The medium of claim 23, further comprising code for determining data indicative of a webpage from which the request was generated.

25. The medium of claim 24, further comprising code for storing data indicative of the webpage from which the request was generated.

26. The medium of claim 25, further comprising code for augmenting the stored data with chat-application code.

27. The medium of claim 26, wherein chat-application code is not embedded in the webpage from which the request was generated.

28. The medium of claim 27, wherein chat-application code is not permitted to be embedded in the webpage from which the request was generated.
